(19) United States
(12) Patent Application Publication
(10) Pub. No.: US 2004/0172439 A1
(43) Pub. Date: Sep. 2, 2004

(54) Unified multiplier triple-expansion scheme and extra regular compact low-power implementations with borrow parallel counter circuits

(75) Inventor: Rong Lin, Geneseo, NY (US)

Correspondence Address: Paul J. Farrell, DILWORTH & BARRESE, LLP, 333 Earle Ovington Blvd., Uniondale, NY, 11553, US

(73) Assignee: THE RESEARCH FOUNDATION OF STATE UNIVERSITY OF NEW YORK, ALBANY, NY

(21) Appl. No.: 10/728,485

(22) Filed: Dec. 5, 2003

Related U.S. Application Data
(60) Provisional application No. 60/431,373, filed on Dec. 6, 2002.
(60) Provisional application No. 60/431,372, filed on Dec. 6, 2002.

(51) Int. Cl. G06F 7/52

(52) U.S. Cl. 708/620

(57) ABSTRACT

A unified, extra regular, complexity-effective, high-performance multiplier construction method. The method is applicable to a whole spectrum of n×n-b pipelined or non-pipelined multipliers for 10≦n≦81, with no more than two levels of tripling process for each construction. The method includes a library containing 3-b to 9-b borrow parallel small multipliers, used for compact, low-power implementation. The multipliers are developed based on the novel counter circuitry, called borrow parallel counter, which utilizes 4-b 1-hot encoded signals and borrow bits, i.e., bits weighted 2. Exampled by a 54×54-b (bit) multiplier, the method allows large multipliers to be generated from smaller multipliers, tripling the size in each expansion (6×6-b to 18×18-b to 54×54-b). This significantly reduces the complexity of state of the art designs and achieves full self-testability without sacrificing high-performance.

### GOVERNMENT RIGHTS

This invention was funded, at least in part, under grants from the National Science Foundation, Nos. MIP-9630870, CCR-0073469 and New York State Office of Advanced Science, Technology & Academic Research (NYSTAR, MDC) No. 1023263. The Government may therefore have certain rights in the invention.

### BACKGROUND OF THE INVENTION

1. Field of the Invention

The present invention relates generally to very large-scale integrated (VLSI) circuits and more specifically to low-power, high-performance, self-testing VLSI multiplier circuits having a reduced number of transistors.

2. Description of Related Art

The (n×n-b) bit high-performance multiplier designs, where n≧10, often have the following major disadvantage. Both, Booth and non-Booth designs (see, A. D. Booth, A Signed Binary Multiplication Technique, Quart. J. Mech. Appl. Math., vol. 4, 1951), are constructed based on the schemes of generation and reduction of a single large partial product bit matrix, usually with Wallace tree structure processing in parallel (see, C. S. Wallace, A Suggestion For A Fast Multiplier, IEEE Trans. Electronic Computers, Vol. Ec-13, 1964, pp. 14-17). The schemes are intrinsically irregular and not exhaustively self-testable, e.g., requiring built-in test circuits. This is due to the initial partial product bit matrix having a triangle or trapezoid shape, and the multiplier circuits having low controllability and observability for test, particularly for the most commonly used Booth multipliers. The area cost, power cost, layout cost, and the test cost in dealing with such irregularities are significant.

The functions of conventional multipliers are divided into three stages, the generation stage of the partial products, followed by the adding stage of the partial products, and the last stage of the final addition. Since the last stage usually employs a standard fast adder, it is often excluded from the discussion.

Two recently proposed designs, seen as the typical examples of the improved conventional architectures, are the rectangular-styled Wallace tree multiplier (RSWM) described in N. Itoh, Y. Naemura, H. Makino, Y. Nakase, T. Yushihara, Y. Horiba, “A 600 MHz, 54×54-bit Multiplier With Rectangular-Styled Wallace Tree”, IEEE JSSCs, Vol. 35, No2, February 2001, (Itoh) and the limited switch dynamic logic multiplier (LSDL) described in Robert Montoye, Wendy Belluomini, Hung Ngo, Chandler McDowell, Jun Sawada, Tuyet Nguyen, Brian Veraa, James Wagoner, Mike Lee, “A Double Precision Floating Point Multiplier” Proc. of 2003 IEEE ISSCC, February, 2003. (Montoye)

The RSWM design proposes a rectangular Wallace-tree construction method. In this method, the partial products are divided into two groups and added in the opposite directions. The partial products in the first group are added downward, and the partial products in the second group are added upward. This method eliminates the dead area that occurs in a general Wallace tree design. It also optimizes the carry propagation between the two groups to realize the high speed and a simple layout. Applying the method to a 54×54 bit multiplier, a 980 mm×1000 mm (0.98 mm²) area size and a 600-MHz clock speed have been achieved using 0.18 mm Complementary Metal Oxide Semiconductor (CMOS) technology.

The LSDL multiplier design proposes a method of merging pre-charged dynamic logic into the input of every latch, which differs for circuits merging logic and latches described in Daniel W. Dobberpuhl, Richard T. Witek, Randy Allmon, Robert Anglin, David Bertucci, Sharon Britton, Linda Chao, Robert A. Conrad, Daniel E. Dever, Bruce Gieseke, Soha M. N. Hassoun, Gregory W. Hoeppner, Kathryn Kuchler, Maureen Ladd, Burton M. Leary, Liam Madden, Edward J. McLellan, Derrick R. Meyer, James Montanaro, Donald A. Priore, Vidya Rajagopalan, Sridhar Samudrala, and Sribalan Santhanam, “A 200-MHz 64-b Dual-Issue CMOS Microprocessor”, IEEE JSSCs, Vol. 27, No11, November 1992 (Dobberpuhl). In Dobberpuhl, clocks are used to tri-state the output of a static logic gate, while in LSDL multipliers clocks are used to control pre-charge and evaluation phases of dynamic logic and latch the outputs. This allows most of the speed advantages of the dynamic logic to be preserved while eliminating most of the traditional dynamic logic power penalty. The LSDL design achieves a 2.2 GHz 53×54 pipelined multiplier, fabricated in 0.13 mm CMOS technology with an area of 315 mm×495 mm (0.155 mm²) which reduces the area required by RSWM design by 50% (scaled for technology) and increases the operation frequency at the same time.

Both RSWM and LSDL multipliers are Booth encoded Wallace tree designs and have yielded multipliers with great performance and cost reduction in terms of an area or area-power. However, the design complexities in both RSWM and LSDL multiplier. are increased accordingly. The RSWM design uses a high-speed redundant binary (RB) architecture (see Dobberpuhl), a complex optimization process, and an extra area for carry-signal propagation to add upward partial products in the lower-bit group. The LSDL design requires well-controlled dynamic circuit and clock design with proper pulses, long enough for evaluation of the dynamic logic and short enough to prevent a significant leakage on the dynamic node.

Furthermore, the RSWM and LSDL design requires relatively expensive custom processing in laying out of most of its circuits. Finally, building test circuitry is required in both of these designs.

### SUMMARY OF THE INVENTION

A unified, extra regular, complexity-effective, high-performance multiplier construction method is discussed and is applicable to a whole spectrum of n×n-b pipelined or non-pipelined multipliers for 10≦n≦81, with no more than two levels of tripling processing for each construction. The method includes a library containing 3-b to 9-b borrow parallel small multipliers, used for compact, low-power implementation.

The multipliers are based on the novel counter circuitry, called borrow parallel counter, which utilizes 4-b 1-hot encoded signals and borrow bits, i.e., bits weighted 2. The multiplier circuit comprises at least two input numbers, each trisected into three segments, a plurality of Carry Select Adders (CSAs), a plurality of 3-b to 9-b borrow parallel small multipliers interconnected to the CSAs. The small multipliers are arranged to minimize the interconnection to the CSAs, and a plurality of output bits.

The small borrow parallel multiplier process bit input, and comprise an array including a plurality of identical counters with a simple layout arranged in a plurality of columns, wherein the “borrow-effect” naturally re-arranges bits being processed so that an actual number of bits processed in each column are balanced; minimal line connections within each line, wherein a single counter is used in each column; and a plurality of output bits most having similar delay, wherein the multiplier requires little cost in transistor sizing and delay equalization.

Exampled by a 54×54-b (bit) multiplier, the method allows large multipliers to be generated from smaller multipliers, tripling the size in each expansion (6×6-b to 18×18-b to 54×54-b). This significantly reduces the complexity of state of the art designs and achieves full self-testability without sacrificing high-performance.

The triple expansion method optimizes only one column of a plurality of CSA block columns in a multiplier processing a plurality of bit inputs. The method provides a first level of application of a triple expansion scheme P×P, where P is (3m+z1), m is an integer multiplier, and z1 is {0, 1, −1}; and when required expanding the first level of application according to a E×E, where E is (3P+z2) and z2 is {0, 1, −1}.

### BRIEF DESCRIPTION OF THE DRAWINGS

The foregoing and other objects, aspects, and advantages of the present invention will be better understood from the following detailed description of preferred embodiments of the invention with reference to the accompanying drawings that include the following:

FIG. 1 is a diagram of the trisect-decomposing 18×18 product partial matrix according to the present invention;

FIG. 2 is a diagram of the triple-expanded 18×18-b multiplier of the present invention, including Carry Select Adders (CSAs) outputs;

FIG. 3 is a diagram of the triple-expanded 54×54 Multiplier of the present invention;

FIG. 4a is a diagram of the 6×6-b (4, 2)-(3, 2) based virtual multiplier of the present invention (with a rectangular shape);

FIG. 4b is a diagram of the 6×6-b borrow parallel virtual multiplier of the present invention;

FIG. 5 is a diagram of the 5_{—}1 borrow parallel counter of the present invention;

FIG. 6 is a diagram of the full adder of the present invention, for adding three bits, one binary and two 4-b 1-hot encoded bits, without type conversion;

FIG. 7 is a diagram of the functional structure of the 5_{—}1 parallel counter of the present invention;

FIG. 8 is a diagram of a typical application of the 5_{—}1 counter array of the present invention;

FIG. 9 is a diagram of a full-adder embedded in three contiguous borrow parallel counters of the present invention;

FIG. 10A1-10A11 are diagrams of (virtual) multiplier circuits of the present invention, comprising sizes of 3×3b, 3×3, 4×4, 5×5a, 5×5b, 6×6a, 6×6b, 6×6c, 7×7, 8×8, 9×9, respectively;

FIG. 10B1 is a diagram of the organization of the triple-expanded 54×54 multiplier of the present invention, with 2-levels of CSAs;

FIG. 10B2 is a diagram of the internal connections of the triple-expanded 54×54 multiplier of the present invention;

FIGS. 10B3-10B5 are diagrams of right, mid and left sides of the 18×18 multiplier of the present invention;

FIG. 10B6 is a diagram of the Level-2 CSA of the 54×54 Multiplier of FIG. 10B1;

FIG. 10B7 is a diagram of definitions of binary counter blocks (6, 2)×3, (5, 2)×3 and (4, 2)×3 of the present invention;

FIGS. 10B8-10B15 are diagrams of the layout draft for areas A, B, C, D, E, F, H, I, J, K, L, M of the present invention respectively;

FIGS. 11A-11D are diagrams of the decomposition of (3m+1)×(3m+1)-b (m=5) bit matrix, partial product matrix, implementation of the 16×16-b multiplier and rectangular structure of the (3m+1)×(3m+1)-b multiplier, respectively, of the present invention;

FIGS. 12A-12D are diagrams of the decomposition of(3m−1)×(3m−1)-b (m=4) bit matrix, partial product matrix, implementation of 16×16-b multiplier and rectangular structure of the (3m+1)×(3m+1)-b multiplier, respectively, of the present invention;

FIGS. 13A-13D are diagrams of the modified decomposition of (3m+1)×(3m+1)-b (m=5) bit matrix, partial product matrix, implementation of 16×16-b multiplier and rectangular structure of the modified (3m+1)×(3m+1)-b multiplier of the present invention; and

FIGS. 14A-14D are a diagram of the modified decomposition of (3m−1)×(3m−1)-b (m=4) bit matrix, partial product matrix, and the implementation of 11×11-b multiplier and rectangular structure of the modified (3m−1)×(3m−1)-b multiplier of the present invention.

### DETAILED DESCRIPTION OF THE INVENTION

The present invention provides a new multiplier triple-expansion scheme. The scheme is developed based on the work described in R. Lin, “Reconfigurable Parallel Inner Product Processor Architectures”, IEEE T LSI, Vol. 9, No. 2. April 2001, pp. 261-272 (hereinafter “RL1”); R. Lin. and R. B. Alonzo, “An Extra-Regular, Compact, Low-Power Multiplier Design Using Triple-Expansion Schemes and Borrow Parallel Counter Circuits,” in Proc. of workshop on Complexity-Effective Design (WCED, ISCA), Held in conjunction with the 30th Intl. Symposium on Computer Architectures, San Diego, Calif., June 2003; and R. Lin, “Borrow Parallel Counters And Borrow Parallel Small Multipliers” and “Triple-Expanded Multipliers”. New Tech. Disclosures of SUNY, August 2002, also respectively described in U.S. Provisional Patent Applications Nos. 60/431,372 and 60/431,373, (hereinafter “RL2”), which are both incorporated herein by reference.

The present invention provides improved performance through use of a new partial product bit matrix decomposition method as well as a novel extra-compact, low-power large parallel counter circuitry. The present invention is an improvement over the conventional large Booth multipliers, and is highly regular and compact in layout. The inventive scheme can be exhaustively tested without extra built-in test circuits.

The decomposition and re-arrangement of the bit matrices provided by the scheme of the present invention significantly reduces the number of recursive levels required for the construction of large multipliers, in particular to no more than two. Furthermore, the present scheme handles decomposition of any type of partial product matrix, without being restricted to 2m×2m or 3m×3m only. More specifically, the inventive scheme handles decomposition of n×n matrices with n=3m, 3m+1 and 3m−1 in a similar manner. This allows for application of the scheme to the whole spectrum of multiplier designs with the same efficiency.

The building block of the inventive multiplier is a novel CMOS parallel counter circuitry, utilizing 4-b 1-hot encoded signals, and borrow bits, i.e., bits weighted two. The borrow parallel counter circuits greatly simplify the structures of small multipliers, as a single array of almost identical counters, and improve the compactness and effectiveness of the circuit layout. The circuit layout contributes significantly to the efficient implementation of the triple expanded multipliers. It should be noted that in addition to using the provided borrow parallel small multipliers for the implementation of the inventive scheme, those skilled in the art will readily recognize that other small multipliers may be used as well by the inventive scheme.

Based on the preliminary layouts and simulations, the proposed 54×54-b pipelined multiplier, as a typical example, is implemented in an area of 434.8×769.5=334,578.6 m²with a 0.18 m technology, achieving a 1 GHz at 1.8V supply and a good low-power performance. The area is 37.9% of the area of RSWM design, or 75.8% of the LSDL area (scaled for technology).

18×18 Multipliers

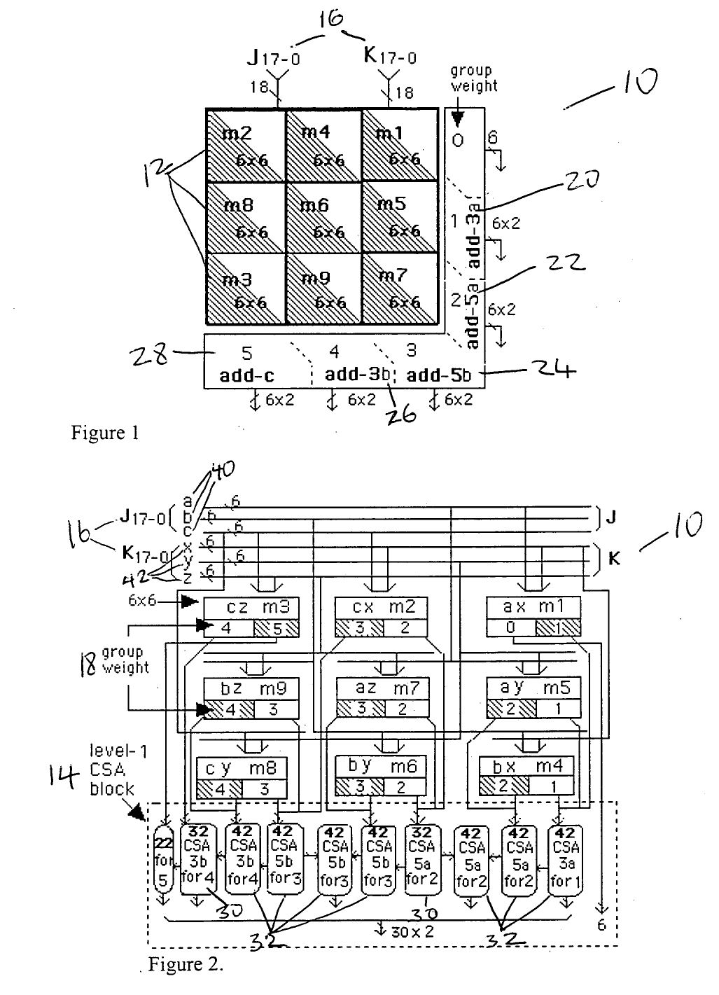

FIGS. 1 and 2 illustrate an 18×18-b virtual multiplier 10, which produces two output numbers instead of one. The multiplier 10 is constructed using nine 6×6-b small multipliers 12 and five adders 20-28, using a trisect decomposition approach. Two 18-b input numbers 16 are first trisected into input group-bits or six bit segments a, b, c 40 and x, y, z 42, partitioned, and distributed to nine 6×6-b multipliers 12, where the 6×6 partial product matrices are generated and the nine 12-b products are produced. The adders 20-28 then add weighted bits of the nine products. The weight range 18 of each bit group, received by the adders, is indicated by a number, 1 to 5, at the top of each adder or receiver block 20-28.

In FIG. 1, adder-3a (20) adds three 6-bit numbers to result in the final sum's bits 6 to 11 and carries to adder-5a (22). Adder-5a (22) then adds five 6-bit numbers (and the carry-ins) to result in the final sum's bits 12 to 17 and carries to adder-5b (24). Similarly, adder-5b (24) adds five 6-b numbers and adder-3b (26) adds three 6-b numbers to result in final sum's bits 18 to 23 and bits 24 to 29 respectively. The carry-out bits from adder-5b (24) will be added by the last adder, adder-c (28), to result in the six most significant bits (MSB). Usually no addition is required for the output bits 0 to 5. All 36 bits of the product have been correctly produced.

FIG. 2 illustrates a triple-expanded 18×18 multiplier schematic re-positioned along its inputs distribution. Because small multipliers are independent of receiving inputs, (trisected segments of the input numbers) and carrying out multiplications, they can be re-arranged to minimize the interconnection between the small multipliers and the Carry Select Adders (CSAs) 14 with 2 levels of 3:2 (30) and 4:2 (32) counters plus a latch for each output bit. The two 18-b input numbers J and K 16 are trisected into segments: a, b, c 40 and x, y, z, 42 each of 6 bits. They are distributed to the 9 small multiplier blocks. Since the 18×18 multipliers are virtual multipliers, each providing two output numbers, no final addition is required.

54×54 Multiplier

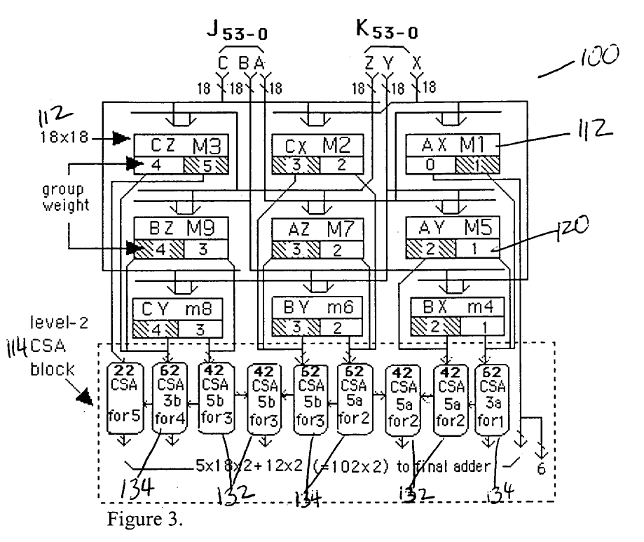

When the inventive circuit scheme is applied recursively for one more level, it results in the 54×54-b multiplier 100 illustrated in FIG. 3. The inventive circuit 100 comprises nine 18×18-b triple-expanded virtual multipliers 112 and a level of CSAs adders called level-2 CSAs 114, which is a row of 2 levels of binary (4, 2) and (6, 2) counters 132, 134 plus latches, residing at the bottom of the 54×54-b multipliers 100. The outputs (two-number pairs) of the CSA adders 114 are sent to the fast final adder, which is not shown.

The process (excluding the final addition) requires three stages of pipelined operations:

(1) base, i.e., 6×6-b virtual multiplication,

(2) level-1, i.e., 18×18-b bit reduction, and

(3) level-2 bit reduction.

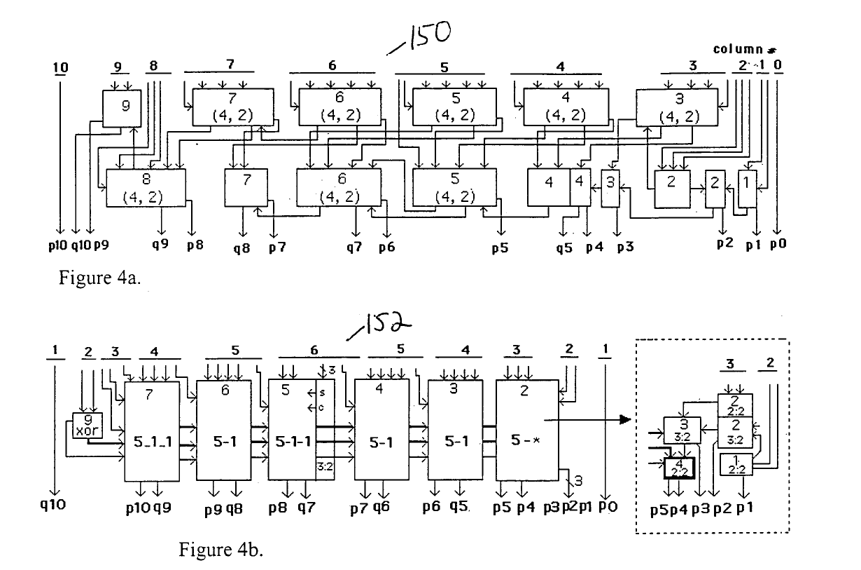

Since these three operations require comparable delays, the scheme fits well for a 3-stage (or 3.5-stage) pipelining and multiply-accumulate implementations. Two output numbers, of 18×18 multiplier 112 each, are routed to the CSAs 114 in parallel, passing through zero or three or six rows of 6×6 multipliers. Since the height of each 6×6 multiplier 150, illustrated in FIG. 4a is made as short as possible, the interconnection distance is minimized.

Efficient small multipliers of any magnitude may be considered as bases for the triple expansion to yield large multipliers. In an exemplary embodiment the present invention has adopted two types of 6×6 multipliers shown in FIGS. 4a and 4b respectively. The multiplier 150 of FIG. 4a is a small (3,2)-(4,2) counter based Wallace-tree style multiplier, described in R. Lin, “Low-Power High-Performance Non-Binary CMOS Arithmetic Circuits,” in Proc. of 2000 IEEE Workshop on SiGNAL PROCESSING SYSTEMS (SiPS), Lafayette, La., October, 2000, pp. 477-486 (hereinafter “RL3”). The multiplier 152 of FIG. 4b is a borrow parallel small multiplier which is a single array of a borrow parallel counter. The counter circuits will be described in detail below. Both multipliers receive two 6-bit input numbers, J and K, 16 (FIG. 1), generate a small partial product bit matrix and then reduce it into two numbers P (p10−p0) and Q (q10−q5), so that J*K=P+Q*2**5. The (4,2)-(3,2) based 6×6 multiplier 150 of FIG. 4a uses slightly fewer transistors, while the borrow parallel 6×6 multiplier 152 of FIG. 4b has a more compact layout and mainly performs logic with 4b-1-hot signals that feature lower switching activity and use fewer hot lines.

4-b 1-Hot Borrow Parallel Counters

Parallel counter circuits utilize 4-b (bit) 1-hot or non-binary signals. Each encoded signal has 4, instead of 2, signal lines with only one of these signals being logic level high at any time. Such signals, representing integers ranging from 0 to 3, are shown in Table 1.

These parallel counter circuits are superior in several aspects, including speed and power, when compared with traditional binary counters for multiplier designs described in RL1, RL2 and RL3, referenced above. However, to reduce 7 bits into 3 or 2 bits, the previously proposed circuits require 8 to 10 additional transistors for signal type conversion, from non-binary to binary.

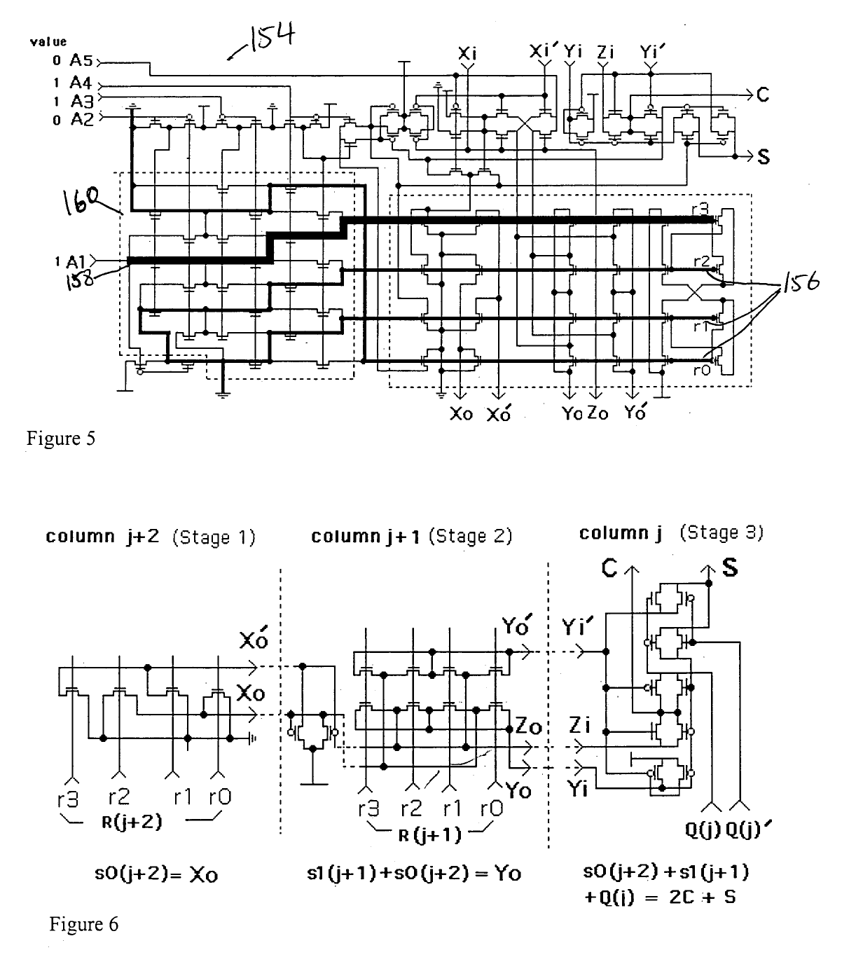

The new family of circuits, called borrow parallel counters, including 5_{—}1, 5_{—}1_{—}1, 6_{—1,} and 6_{—}0, does not require type conversion, and requires a minimum number of transistors with a large ratio of negative-channel Metal Oxide Semiconductor (nMOS)/positive-channel Metal Oxide Semiconductor (pMOS), and yet shows superior layout and performance. As shown in FIGS. 5 and 6, the counter not only utilizes both 4-b 1-hot signal encoding and borrow bits, i.e., input bits weighted 2 instead of 1, but also provides an embedded full adder adding non-binary (4-b-1-hot) and binary signals without type conversion. For example, if the non-binary signal R=0100=2 is produced, additional circuits are usually required to convert it into two bits, i.e., s0=0, s1=1, before it can be used by a conventional circuit. This leads to a significant reduction in circuit complexity. The circuit is on its way to become a new type of a building block, replacing traditional (2, 2), (3, 2), i.e., half-adder, full-adder, and (4, 2) parallel counters for some arithmetic processor designs.

FIG. 5 illustrates a parallel counter 154 designated 5_{—}1 borrow parallel counter. The counter 154 includes five input bits A1-A5, and bit A5 weighted two. This parallel counter circuit and its variants possess the following-three features:

(1) Each counter, at high speed, reduces 5 or 6 input bits (one or two being borrowed bits) into 2 output bits, with a few in-stage carry in and out bits.

(2) The majority of the transistors are gated by 4-b 1-hot signals, or used to pass 4-b 1-hot signals, as illustrated in FIG. 6, which leads to the reduction of both switching activities and the flow of hot signals by about half of the normal (see RL1, RL2, RL3). The low-power features of the 5-1 borrow parallel counter are illustrated in FIG. 5 by the bold lines 156 which show the 4-b 2-hot signal, and the double bold line 156 is for the 1-hot bit. The transistors in a dotted box 160 are gated by (used to pass) the 4-b 1-hot signal, which reduces switching activities and leakage.

(3) The ratio of nMOS/pMOS is 2.4 (instead of 1 for traditional CMOS) and a compact layout can be achieved easily.

TABLE 1

| | | | | | |
|---|---|---|---|---|---|
| R = | r3 | 0→ | 0→ | 0→ | 1→ |
| | r2 | 0→ | 0→ | 1→ | 0→ |
| | r1 | 0→ | 1→ | 0→ | 0→ |
| | r0 | 1→ | 0→ | 0→ | 0→ |

| | | | | |
|---|---|---|---|---|
| decimal value of R | 0 | 1 | 2 | 3 |
| binary value of R = s1s0 | 00 | 01 | 10 | 11 |
| binary value of s0 (encoded by R) | 0 | 1 | 0 | 1 |
| binary value of s1 (encoded by R) | 0 | 0 | 1 | 1 |

Table 1 shows the 4-b 1-hot encoding scheme. The unique bit positions determine the values of a 4-b 1-hot signal. The change of an R value from one signal to another causes the change of bit-values in no more than two lines, which reduces switching activity of the circuit. In addition at any logic stage there is only one hot bit on four signal lines, which reduces static leakage power.

FIG. 6 shows a full adder circuit which adds three bits s0, s1 and Q, represented by two 4-b 1-hot signals and a binary signal without type conversion. The components and the typical application of the 5_{—}1 borrow parallel counters are illustrated in FIGS. 8-10.

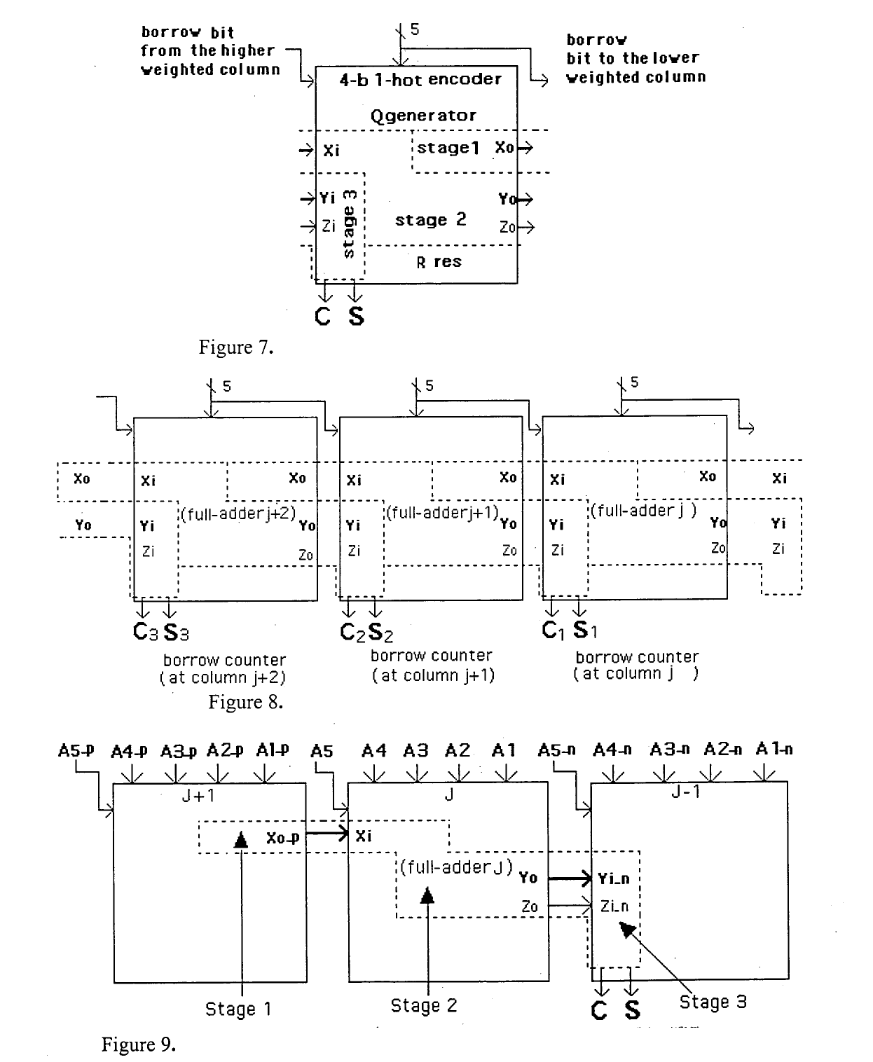

Refering to FIGS. 5 and 7, the 5_{—}1 borrow parallel counter is shown to comprise seven components:

(1) The 4-b 1-hot signal encoder, which encodes (A1+A2+A3+A4) mod 4 into R=s0′+2s1′, intermediate results s0′ and s1′ are not shown;

(2) Adding-A5 that adds Xi, s1′ and A5. Note that s0+A5 mod 2=s0; no change for s0 is one of advantages of using borrow bits;

(3) Q-generator that generates q=(A1+A2+A3+A4+2A5)/4;

(4) R-restoration (R-res) that restores non-full swing 4-b 1-hot signal R into a full swing one;

(5) , (6), and (7) Three stages (components) of the embedded full adder circuit as detailed in FIGS. 6 to 9. Each 5_{—}1 borrow parallel counter co-works with its upper and lower neighbor 5_{—}1 counters, as shown in FIG. 9, to produce two output bits S and C. That is because s0, s1, and q within each counter are weighted 1, 2, and 4 respectively. The actual s0, s1, and q being added by the full adder are from three adjacent columns with s0 in the highest column, thus they have the same weight. There is no explicit data type conversion and the output is in binary form.

The inventive circuit simulations have shown the superiority of the new counters in comparison with the conventional ones in all aspects including delay, area, and power dissipation, which will be clearer when the circuits are applied in small multiplier designs. The 5_{—}1 borrow parallel counter uses 78 transistors, about two thirds of which are nMOS cells, and 56 out of 78 (or 73%) of the transistors are either gated by or used to pass 4-b 1 -hot signals, leading to a significant reduction in power-consuming activities. The inventive counter implements arithmetic Equation E1. and logic equations shown below.

A1+A2+A3+A4+2A5=s0+2s1+4Q (E1)

Xo=s0; Yo=Xi xor s1; Zo=Xi; S=Yi xor Q;

C=Zi and Yi′ or Q and Yi.

In these equations, s0, s1, Q are temporary parameters, and Xo, Yo, Zo and Xi, Yi, Zi are in-stage carry (out/in) bits. The close variants of the 5_{—}1 borrow parallel counter are denoted by 5_{—}1_{—}1, 6_{—}1 and 6_{—}0, which are similar to 5_{—}1, except for the number of borrow bits, and the component for encoding those bits are slightly different. There is little change in complexity between 5_{—}1 and 5_{—}1_{—}1 as well as between 6_{—}1 and 6_{—}0. The main application of the proposed borrow counters is, a novel technique to reduce in parallel the height of a weighted bit matrix with significant new features which is well suited to efficient Very Large-Scale Integration (VLSI) implementations of arithmetic circuit designs.

Borrow parallel counters may be used for efficient partial product bit reduction for large multiplier designs, e.g., 32b or larger. For example, a 96 transistor 6-1 borrow parallel counter (two output buffers may not be needed) can replace 4 full adders or two (4, 2) counters, possessing all advantages as described above without an increase in circuit transistor count. The simulation results for 5-1 and 5-1-1 borrow parallel counters are provided in Table 2 below.

6×6 Borrow Parallel Multipliers and the Base Multiplier Library

As a building block, the 6×6-b borrow parallel (virtual) multiplier shown in FIG. 4b produces 17 output bits, or two numbers instead of one. Such an output form has two advantages:

1. It is fast. When the 7 least significant bits (LSBs) outputs are produced (through a ripple carry style process) the second 10 MSBs outputs are about ready (through carry save process).

2. It is useful for regular inter-connection and CSA bit reduction; as shown in FIGS. 2 and 3, the two output groups of each base 6×6 block are accurately separated with the lower weighted group as a 6-b number, while the higher weighted group as two 5-b numbers.

The multiplier is an array with five borrow parallel counters. When compared with conventional binary full-adder based counterparts, the small borrow parallel multiplier possesses the following features:

1. It is a single array of identical counters with a simple layout, since the “borrow-effect” naturally re-arranges the bits being processed so that the actual bits to each column are balanced.

2. It requires minimal line connections, since only a single counter is used in each column.

It gives the nearly same, delay for almost all output bits, except a few faster outputs at two ends; therefore little cost is required in transistor sizing and delay equalization. The delay of the circuit of FIG. 4b is about 0.6 ns or 2 times a (4, 2) delay. Table 2 shows the summary of the parallel counters and small multiplier circuits.

TABLE 2

| | | | | 0.18 μm 1.8Y | |
|---|---|---|---|---|---|
| | | | | technology | |
| circuit | | area | $\frac{nMOS}{pMOS}$ | delay (ns) | $\begin{matrix}power \\ ( \frac{μW}{MHz} )\end{matrix}$ |
| counter | | | | | |
| borrow | 5_{—1} | 190 | 2.7 | 0.6 | 0.07 |
| parallel | 5₁₃1₁₃1 | 190 | 2.7 | 0.6 | 0.07 |
| binary | (2,2) | 50.7 | 1.1 | 0.1 | 0.02 |
| counters | (3,2) | 84.0 | 1.8 | 0.16 | 0.036 |
| [8] | (4,2) | 165.5 | 1.5 | 0.3 | 0.045 |
| multiplier | | | | | |
| borrow | 6 × 6 | 1414.17 | 2.3 | 0.7 | 0.46 |
| parallel | | (1) | | | |
| binary | 6 × 6 | 1836.38 | 1.45 | 0.8 | 0.83 |
| (3,2)-(4,2) | | (1.298) | | | |
| based | | | | | |

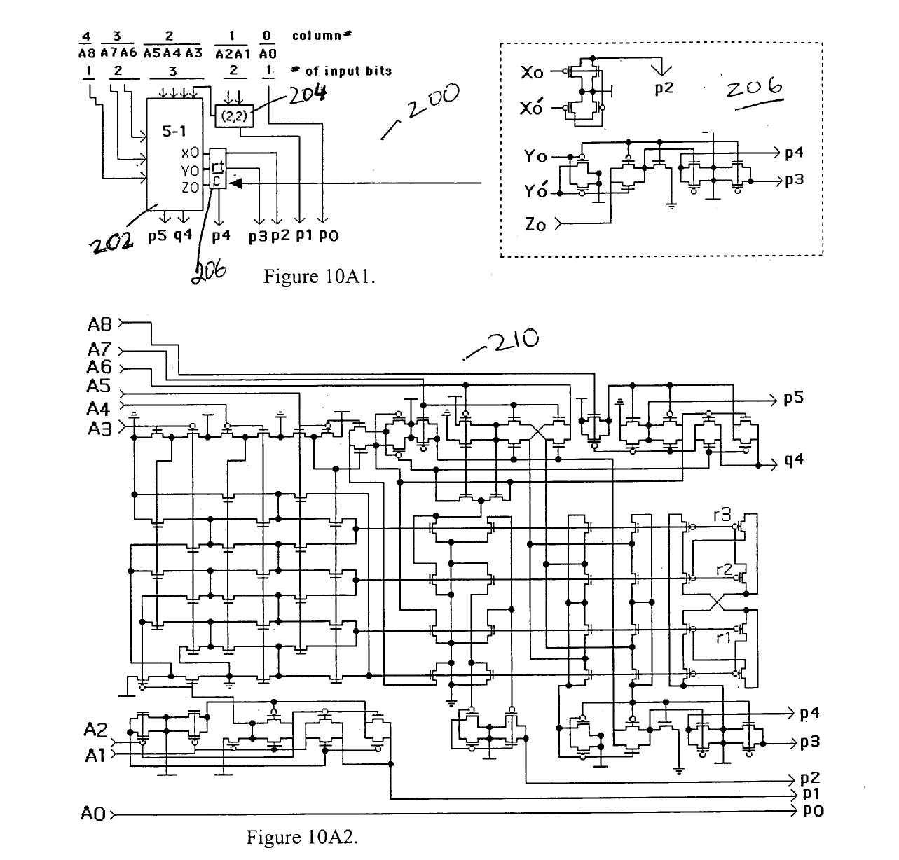

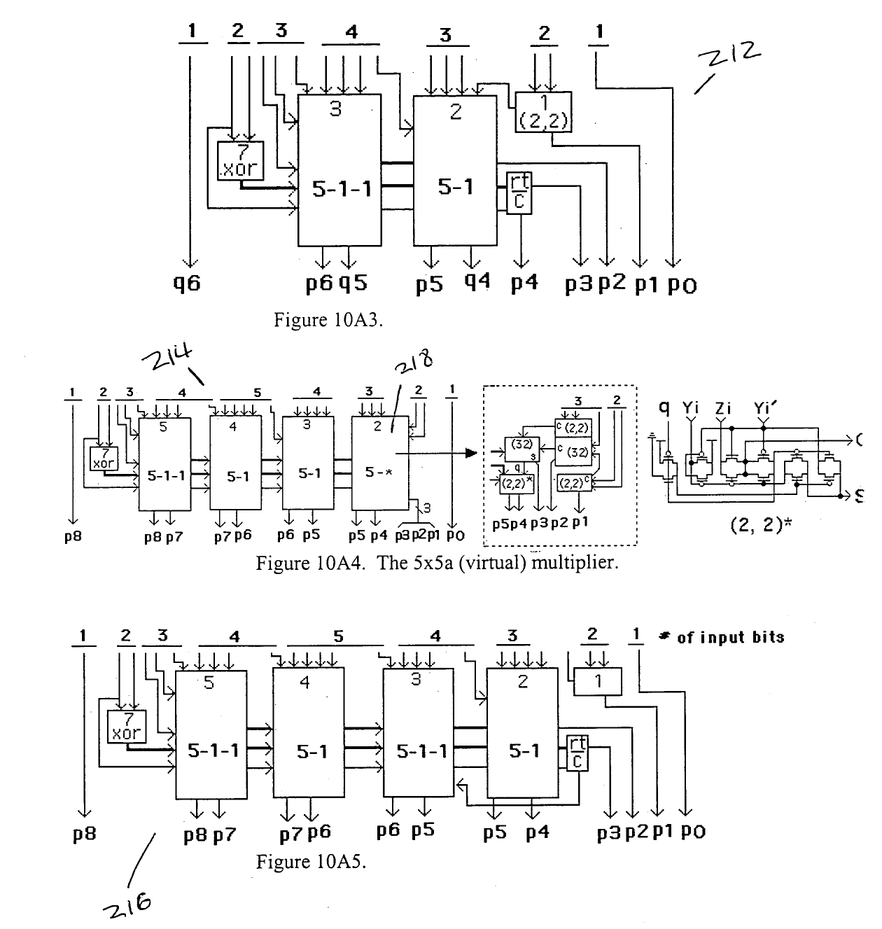

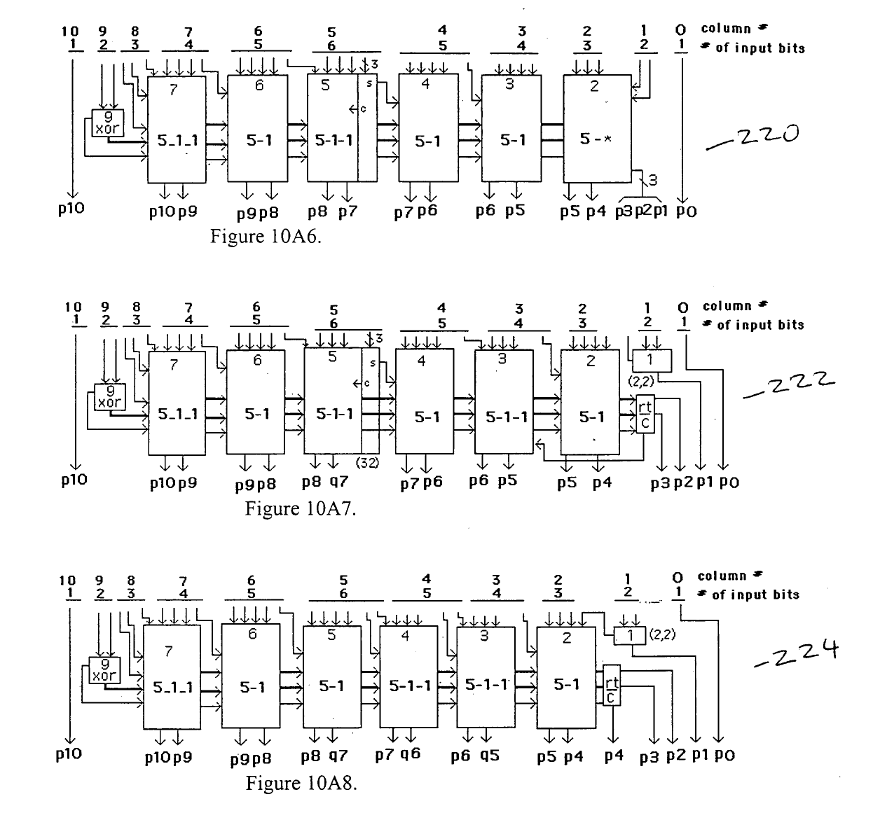

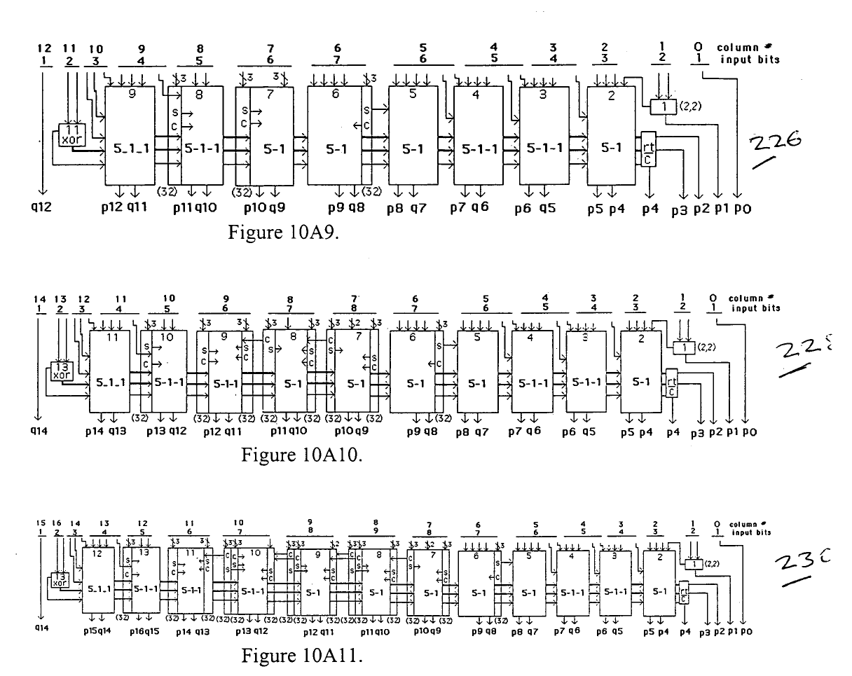

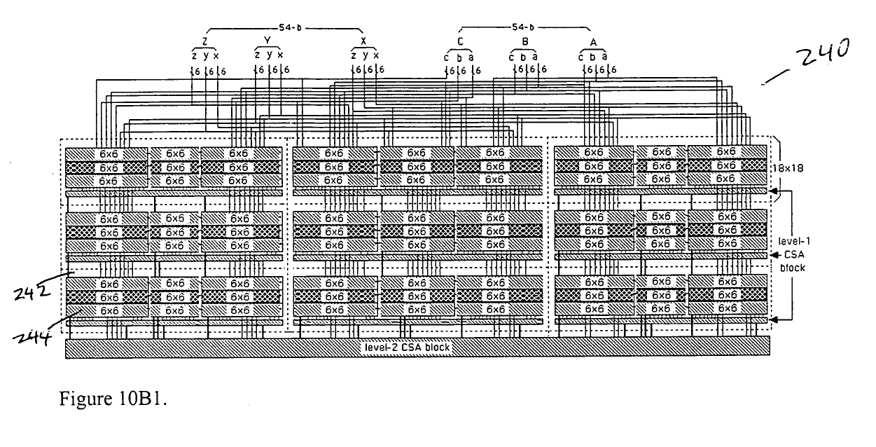

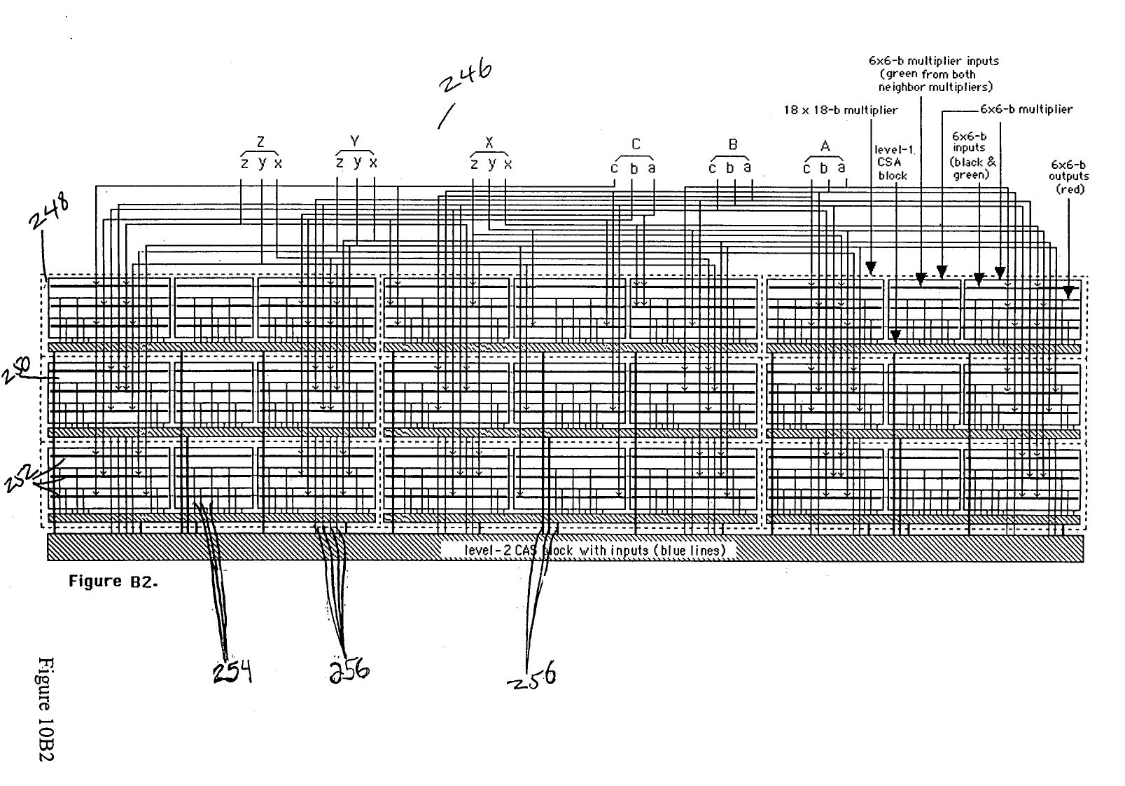

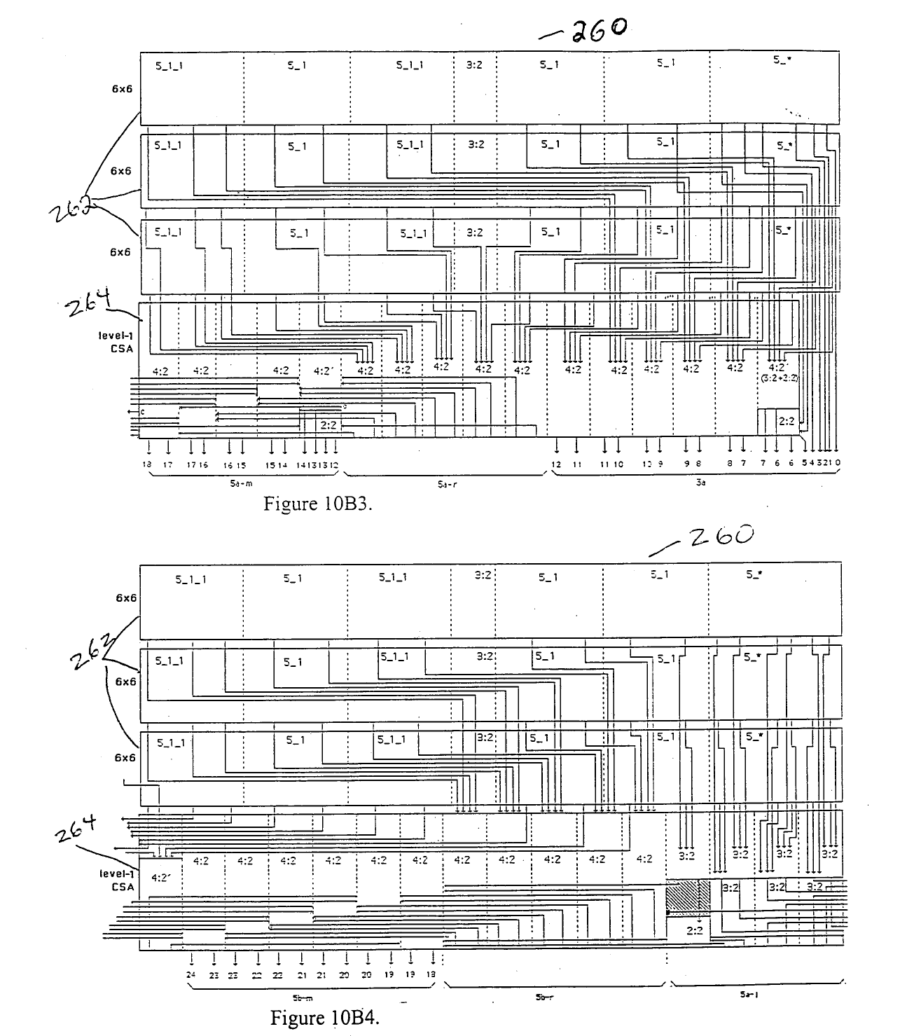

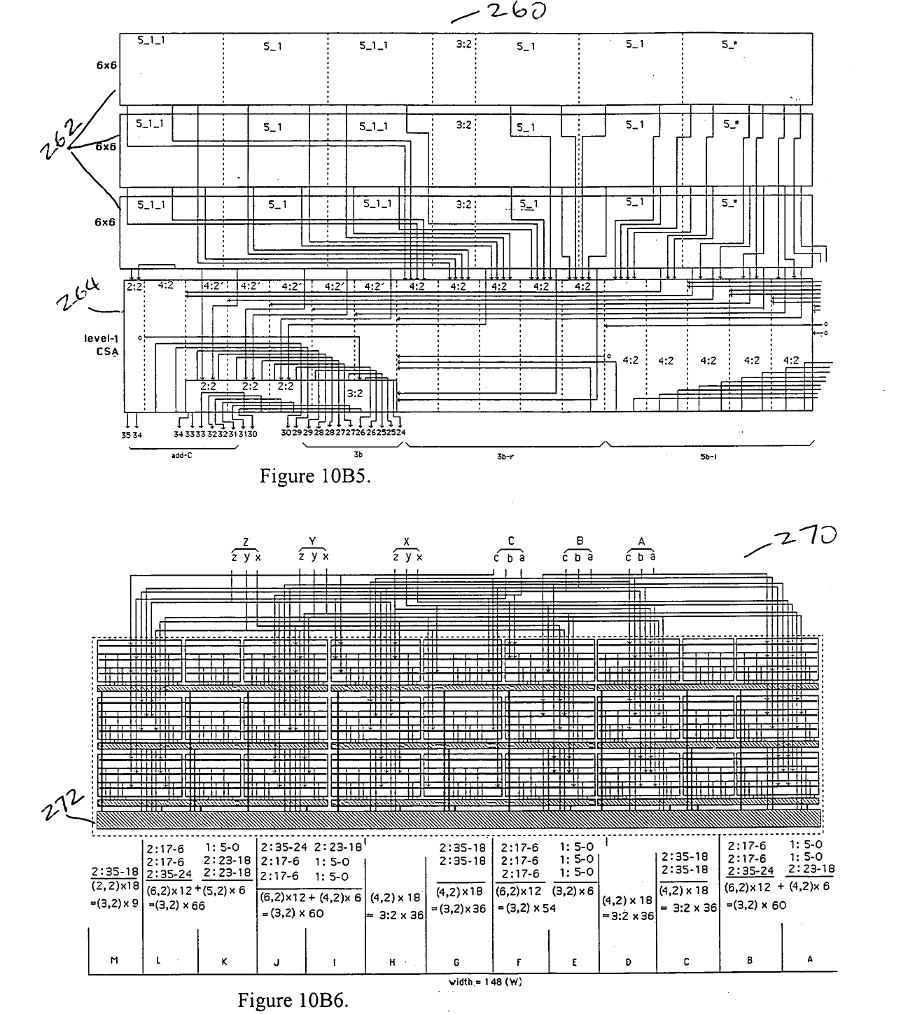

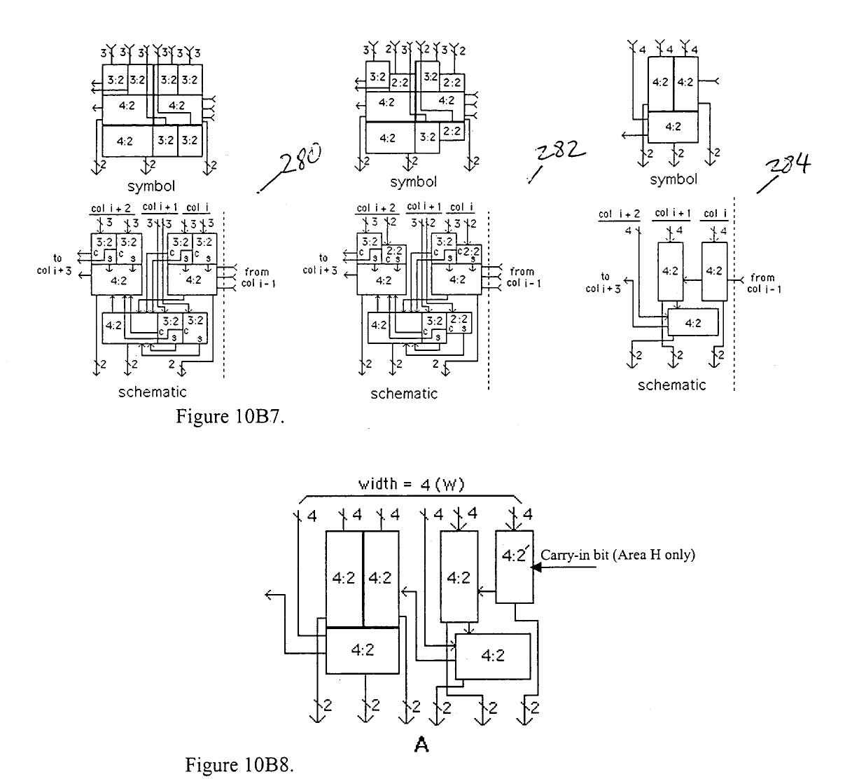

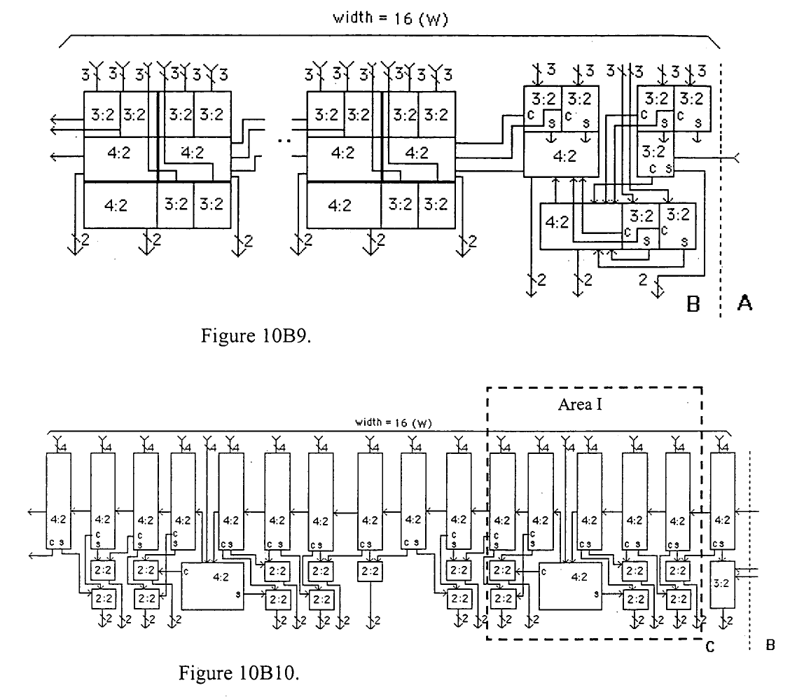

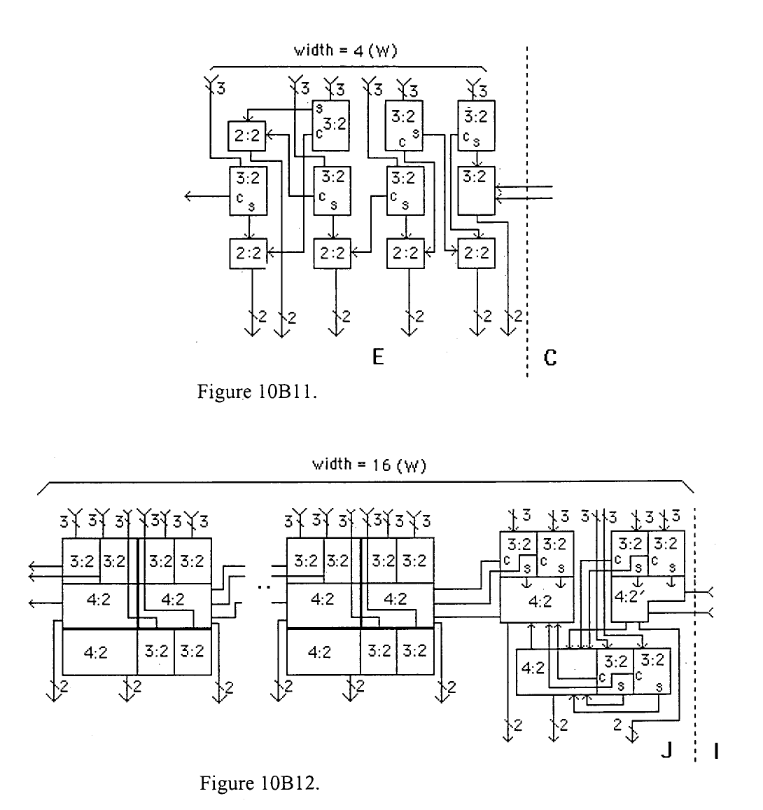

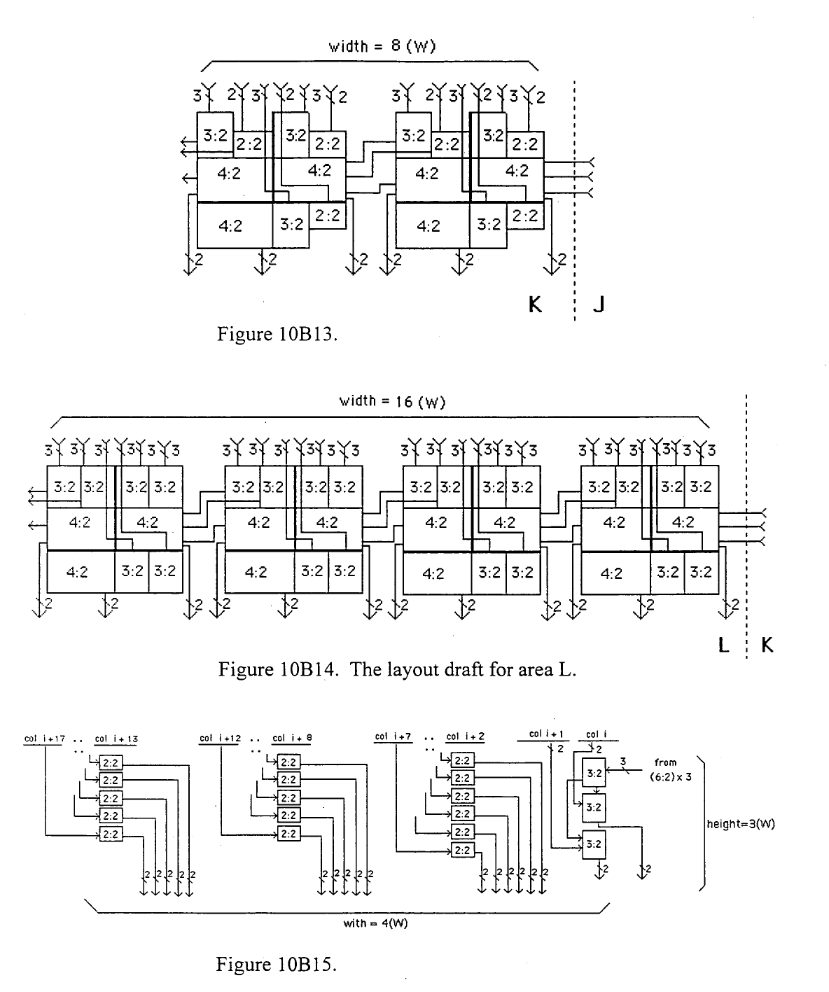

The library containing 3-b to 9-b small base multipliers is provided for compact, low-power implementation, illustrated in FIG. 10a-10a1.

FIG. 10A1 shows the 3×3-b multiplier 200 constructed using a single 5_{—}1 counter 202 plus a (2, 2) binary counter 204 and two restoration circuits with a carry bit plus two buffers 206 denoted by rt-c; the buffers may be unnecessary. Note that the inputs A6 to A8 do not need restoration and that A6 and A7 are weighted 2, while A8 is weighted 4.

FIG. 10A2 shows the complete 3×3-b multiplier 210 with two bits as CSA outputs at position 4, i.e., p4 and q4.

FIG. 10A3 is a 4×4 multiplier 212 consisting of similar components as the multiplier 200 (FIG. 10A1) and with two bit outputs at positions 4 to 6. It should be noted at this time that all virtual multipliers in this library (from 3×3-b to 9×9-b) have the same height, i.e., the height of a single 5_{—}1, which provides the present invention wit extra regularity and compact layout.

FIG. 10A4 and 10A5 show two 5×5-bit multipliers 214, 216. The 5×5a multiplier 214 consists of special binary counters formed in a unit called 5_{—}*218. The multiplier 214 uses slightly larger area but is faster than the 5×5b multiplier 216 (FIG. 10A5).

FIGS. 10A6 to 10A8 show three 6×6b multipliers 220-224. Multiplier 6×6a 220 is the best in speed but uses a larger area. Multiplier 6×6c 224 uses minimal area but produces one more bit in the outputs. Multiplier 6×6b 222 is slightly slower.

FIG. 10A9 to 10A11 show virtual multipliers 7×7-b 226, 8×8-b 228, and 9×9-b 230 respectively. The 7×7-b multiplier 226 has a speed similar to 6×6-b ones, however, the 8×8-b multiplier 228 and the 9×9-b multiplier 230 are about one full-adder delay slower than 6×6-b multipliers. All these multiplier circuits 226, 228, 230 are faster than existing designs.

The Organization

The layouts of the 5-1 and 5-1-1 counters and the 6×6 multiplier in 180 μm CMOS technology (3 metal layers) are implemented to have areas of 12.87×16.0 μm² and 26.5×85.5 μm² respectively.

The design of two CSA blocks, i.e., level-1 and level-2 (14 and 114) shown in FIGS. 2 and 3, are regular structured and may have a layout with straightforward simplicity. The size of level-1 block 14 (FIG. 2), including output latches, is estimated as 34.2×85.5×3 μm². The size of level-2 block 114 (FIG. 3) is about 48.7×85.5×9 μm². The overall pipelined 54×54 multiplier may have a layout (4-metal-layer) in a rectangular area with a height of ((26.5+5)×3+34.2)×3+48.7=434.8 μm and a width of 85.5×9=769.5 μm, or the area of 434.8×769.5=334,578.6 μm². The area is about 37.9% of the area 882,000 μm² of RSWM multiplier (see Itoh), excluding the final adder about 10% of the total area of 980,000 μm², or 75.8% of the area of LSDL multiplier (see Montoye), scaled for technology.

The complexity reduction of the design can be seen from the high regularity of the multiplier logic scheme. Eighty-one identical 6×6 small multipliers, serving as building blocks, are organized in a 9×9 matrix form. The nine identical level-1 CSA adder blocks plus a single level-2 CSA block require minimal custom design workload for optimal layouts. The inputs are organized in a routine network and a three level pipeline interconnection nets in highly regular structure.

The advantages of the design in terms of complexity-effectiveness, compared with the designs of RSWM (see Itoh) and LSDL (see Montoye) may include

(1) simpler CMOS technology and layout;

(2) significantly less amount of custom design work load;

(3) significant area reduction without sacrificing high-performance: an expected pipeline frequency of 1 GHz can be achieved;

(4) low-power achieved through using the compact 4-b 1-hot counter circuitry;

(5) modular and repeated components;

(6) self-testable: It is directly provided by the triple expansion logic scheme.

The regular decomposition of partial product bit matrix enables the circuit possessing high controllability and observability for test, without using a built-in circuit. Exhaustive tests can be performed by testing 81 6×6 small multipliers separately, along with 9 level-1 CSA adder blocks and the level-2 adder block. The test vector length is practically feasible and is easily achieved through the use of an algorithm described in R. Lin and M. Margala, “Novel Design And Verification Of A 16×16-B Self-Repairable Reconfigurable Inner Product Processor”, in Proc. of 12th Great Lakes Symposium on VLSI, NYC, April, 2002, (hereinafter “RL4”). The brief summary and comparison of the three large or floating-point multipliers are provided in Table 3.

TABLE 3

| | | | area | | | |
|---|---|---|---|---|---|---|
| | | | relative value | operation | | |
| | area | | (scaled for | frequency | | self- |
| multiplier | mm² | technology | technology) | GHz | power | testable |
| triple | 0.33 | 0.18 μm | 0.75 | 1 | NA* | no |
| expanded | | 1.8 V | | | | |
| rectangular-styled | 0.98 | 0.18 μm | 2 | 0.6 | NA | no |
| Wallace tree | | 1.8 V | | | | |
| (RSWM) | | | | | | |
| limited switch | 0.15 | 0.13 μm | 1 | 2 | 522 | yes |
| dynamic logic | | 1.2 V | | | mW | |
| (LSDL) 53 × 54 | | | | | | |

As described above, the multiplier has many low-power features, some of which are unique to the present invention; a low-power consumption of the processor can be reasonably predicted. The layout drafts for level-1 and level-2 CSA blocks are shown in FIG. 10B1-10B7.

FIG. 10B1 shows the general organization of a 54×54 triple-expanded multiplier 240 with 2-levels of CSAs with each 18×18 multiplier within a dotted box 242 and each 6×6 multiplier in a rectangle 244.

FIG. 10B2 shows the internal connection of the 54×54-b triple-expanded multiplier 246. All 18×18-b multipliers 248, as well as 6×6-b multipliers 250, are identical except for receiving different input/output and connection lines. Input lines 252 and lines from each multiplier to level-1 CSA 254 are all 6-b each. Lines 256 from level-1 CSAs to level-2 CSAs are all 6-b each for single lines, 24-b each for bold lines.

FIGS. 10B3 to 10B5 show the line connections of an 18×18-b multiplier 260. The multiplier consists of three 6×6-b multipliers 262 plus a level-1 CSA block 264, each 6×6 multiplier 262 has a height of one (4, 2) or two (3, 2) counters and a width of 16.6 times the width of a (4, 2) or a (3, 2) counter (note that the (4, 2) and (3, 2) counters have the same width (see RL4). The experimental layout has shown the area is large enough for all lines to be efficiently connected with minimal or near minimal distance. All connections from the three 6×6 multipliers and mid-side (level-1 CSA 264) counters to the right side of the level-1 CSA 264, and the corresponding outputs of the CSA are shown in the Figures.

FIG. 10B6 shows level-2 CSA block structure 270. All connections from 9 of the 18×18 multipliers to the 11 areas of level-2 CSA, i.e. A, B, C, E, F, G, I, J, K, L, M, with area D and H representing additional areas for outputs from F-E, C, and from G, I-J respectively. Notations in each of the areas of level 2 CSA 272, indicate as follows:

1:5-0 imply receiving one 6-bit number, as bit 0 to bit 5 of the output of an 18×18 multiplier;

2: 23-18 imply receiving two 6-bit numbers, each as bit 18 to bit 23 of the output of an 18×18 multiplier;

(4, 2)×6 implies adding the above numbers by 6 of (4, 2) counters;

(6, 2)×12+(4, 2)×6=(3, 2)×60 implies adding the above numbers by 12 of (6, 2) binary counters plus 6 of (4, 2) counters is equivalent to using 60 of (3, 2) counters and layout draft for all areas and their boundaries shown in FIG. 10B8 to 10B15.

FIG. 10B7 illustrates symbolic and schematic definitions of the binary counter blocks (6, 2)×3 block 280, (5, 2)×3 block 282 and (4, 2)×3 block 284. For each schematic, three areas separated by bold lines represent three (6, 2)s, or (5, 2)s, or (4, 2)s. Similar to the level-1 CSA block the level-2 CSA block has a fixed height of three (3, 2) counters, instead of two (3, 2) counters, and a width that matches the total width of remainder of the processor.

FIG. 10B8 to 10B15 illustrate the calculation and experimental layout that have verified that the area used for the level-2 CSA block may be a perfect rectangle consistent with the regular and extra compact design of the whole 54×54 multiplier.

The total area of level-2 CSA block is as follows: Assuming the width and height of a (3, 2) are W (=5.2 m, with the sharing of a ground or VDD) and H (=14.1 mm) respectively, the total width is SUM (width(A), width(B) . . . width(M)=(4+16+16+12+4+16+16+12+5+16+16+8+4) (W)=145 (W)=(752 m), which closely matches the total width of remainder of the processor that is (16.5+16+16.5)(W)*3=147(W or 769.5 m).

Unified Scheme: Design of a General n×n Multiplier

The method described so far is applicable to any n×n-b multiplier with n=3m, where m is an integer. Below, this method is extended for n=3m+1 and n=3m−1, thus making the triple expansion method applicable to any n×n-b multiplier for all n≦81.

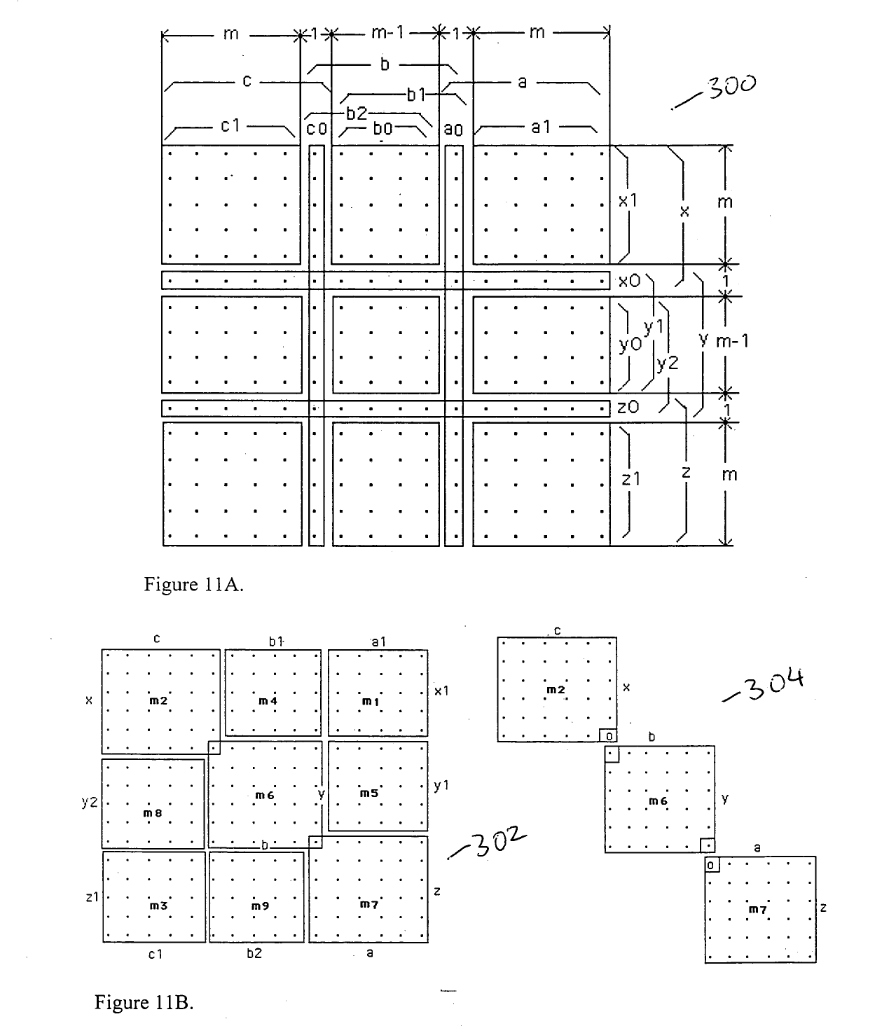

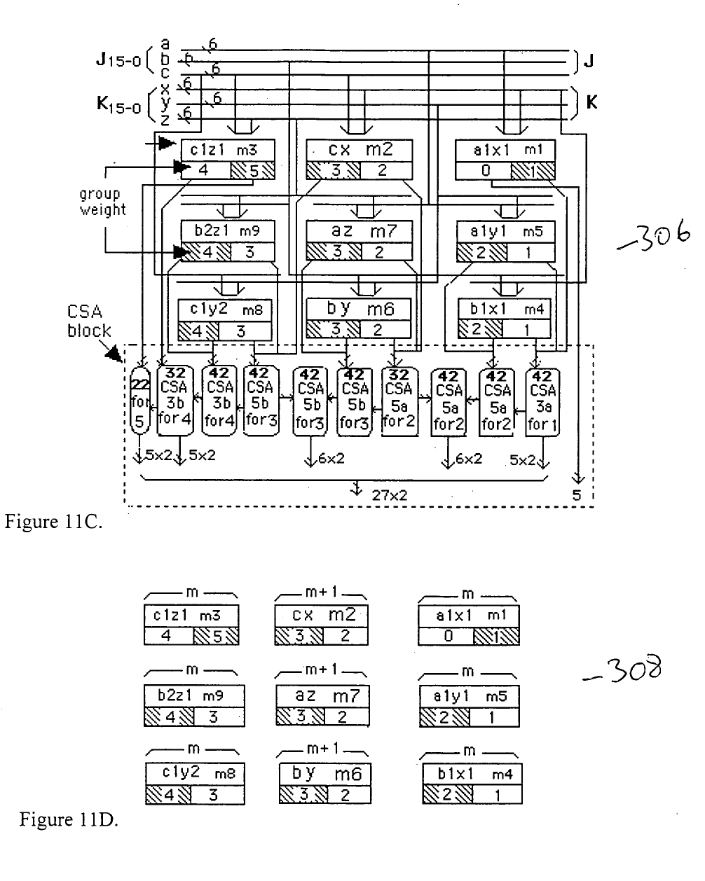

As shown in FIGS. 11 to 14 the decomposition of (3m+1)×(3m+1)-b and (3m−1)×(3m−1)-b partial product matrices are the same as that of a 3m×3m one, except that a few overlapped bits (two in each case) should be used in distribution of inputs, and a few (two in each case) special partial product bits should not be generated or should be set to zero. Two sub partial product matrix sizes are used in each case instead of one, however, the same sizes are in the same column, which makes each multiplier still in a perfect rectangular shape.

To see how this works, FIG. 11A shows the decomposition of a (3m+1)×(3m+1)-b matrix 300, where a0, c0, x0, z0 are all 1-bit width, b0 and y0 are (m−1)-b width, a1, b1, b2, c1 x1, y1, y2, z1 are m-b width. The input of the two (3m+1)-b numbers J and K is partitioned into a, b, c and x, y, and z respectively. They are all (m+1)-b width, and there is one bit overlap between any of two contiguous columns among them. Such decomposition will make it easier to represent the partial product sub-matrices for a unified scheme.

FIG. 11B illustrates the partial product matrix decomposition 302, which is similar to FIG. 1 except that two types of sub-matrices are resulted. Three 1-b larger sub-matrices 304, i.e., (m+1)×(m+1) sub-matrices of m2, m6, and m7 are overlapped by a total of two bits. 0 bits in m6 and m7 imply that those bits are either set to 0 or not generated. To make the triple expansion scheme consistent with FIG. 2, m2 and m7 are each defined to have one partial product bit (as shown) not being generated in multiplier 306 of FIG. 11C, which makes the scheme correct. The multiplier 306 is a 16×16 multiplier implementing (3m+1)×(3m+1) for m=5, with input group-bits a, b, c overlapped and group-bits x, y, z overlapped, and where m2, m7, m6 are 6×6-b, others are 5×5-b base multipliers. Since the height of sub-matrices are actually the same (no more than two input lines of differences between sub-matrices (m+1)×(m+1) and m×m), the triple expansion scheme shown in FIG. 11D will have the same perfect rectangular shape as shown in FIG. 11D.

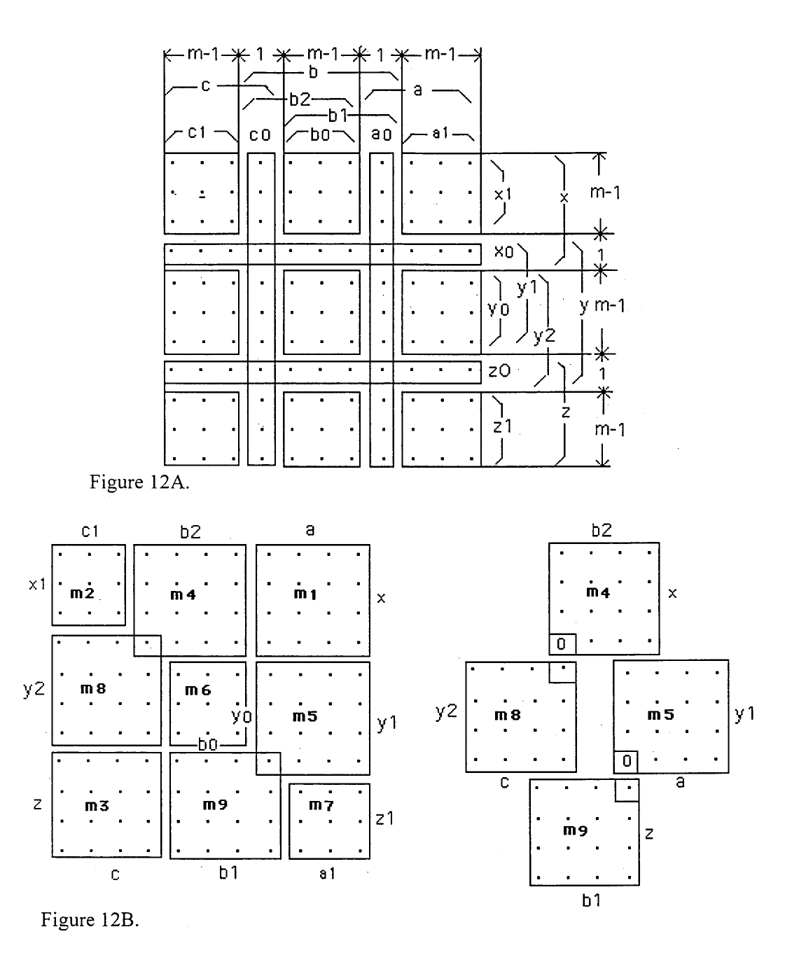

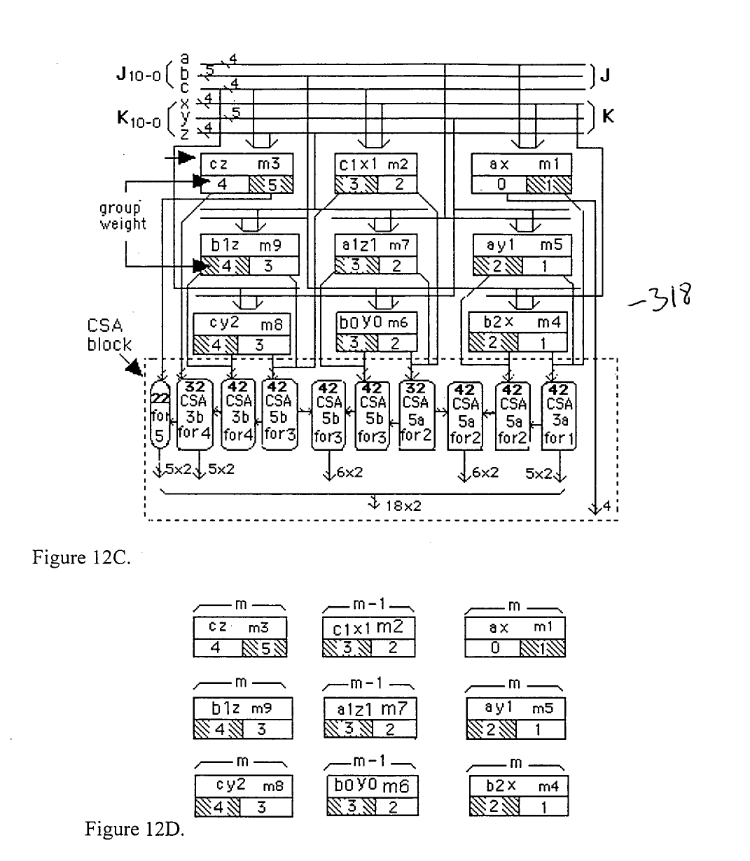

FIGS. 12A to 12D show the decomposition of partial product matrices of size (3m−1)×(3m−1), which is similar to that of (3m+1)×(3m+1) of FIGS. 11A to 11D. In FIG. 12C 0 bits in m4 and m5 mean those bits are either set to 0 or not generated. The overlaps between m4 and m8 as well as m5 and m9 result in two partial product bits not being generated by m4 and m5. In FIG. 12C, the multiplier 318 with input group-bits a, b, c overlapped and group-bits x, y, z overlapped, and where m2, m7, m6 are 3×3-b, others are 4×4-b base multipliers. In FIG. 12D, for the m×m-b and (m−1)×(m−1)-b base multipliers, the heights are about the same.

The Optimized Scheme

Design of (3m+1)×(3m+1) and (3m−1)×(3m−1) Multipliers Based on a 3m×3m Multiplier

The unified scheme described in the last section can be optimized to design (3m+1)×(3m+1) and (3m−1)×(3m−1) multipliers with an existing 3m×3m multiplier. It is easy to see that using the scheme described in the last section, either of the designs requires the modification of both CSA blocks associated with columns 2 and 3. The optimized scheme will simplify the process so that the only CSA block needed to be modified is the one associated with the third column of the (3m+1)×(3m+1) or (3m−1)×(3m−1) multiplier.

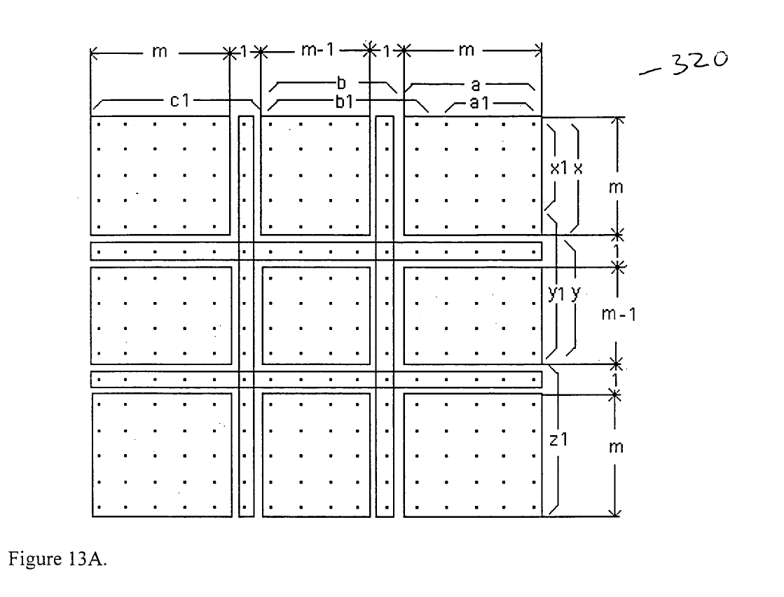

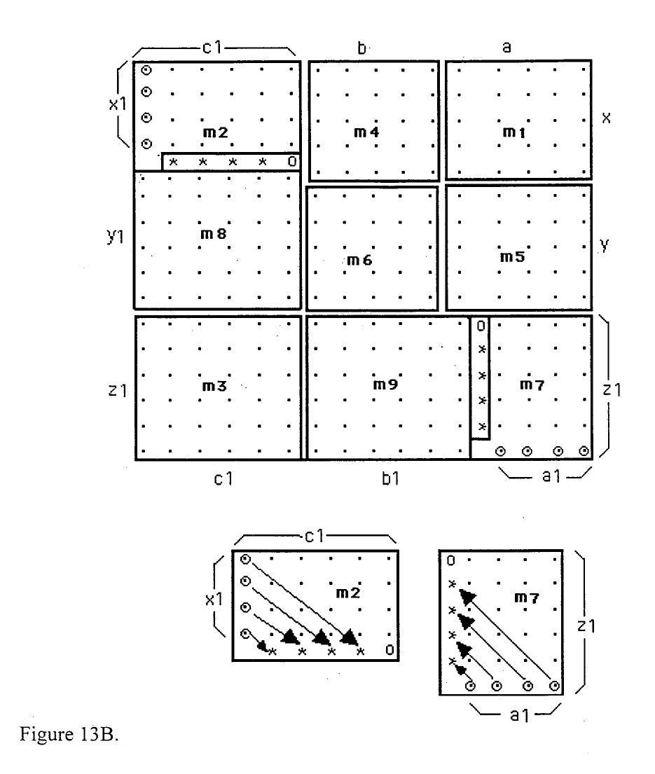

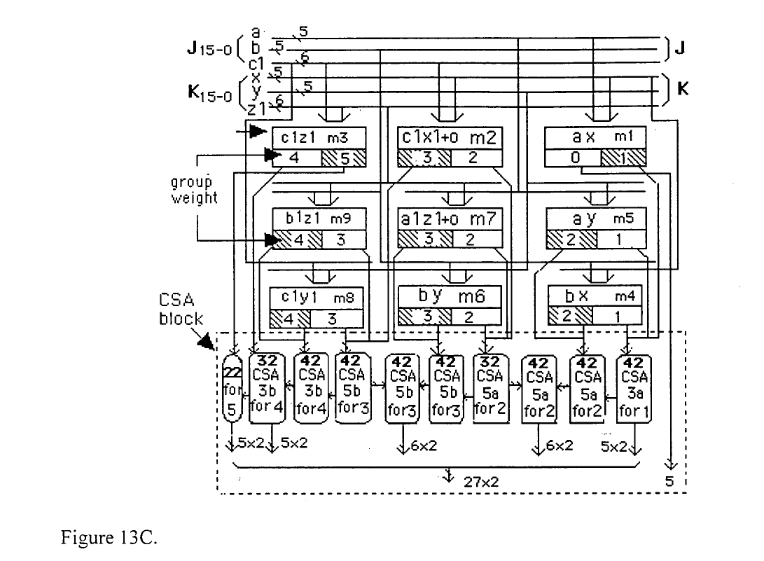

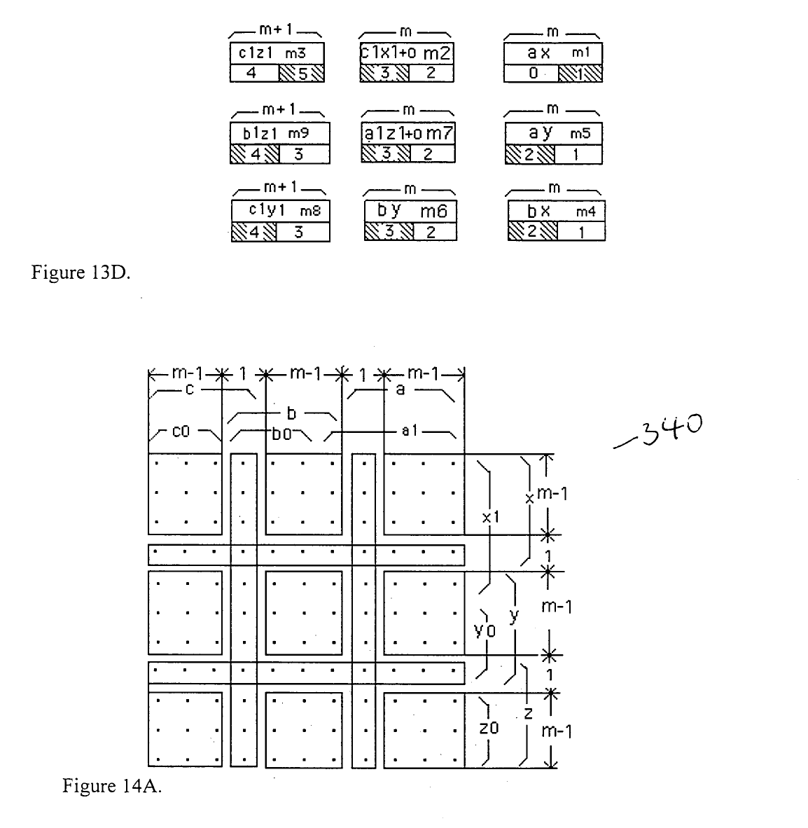

To illustrate how this works, FIG. 13A shows the decomposition of a (3m+1)×(3m+1)-b matrix 320, where each of a, b, x, y represents m-bit, b1, c1 and y1, z1 represents (m+1)-bit, and a1, x1 represents (m−1)-bit. Matrix 320 is the same as matrix 300 (FIG. 11A), except that the values of a, a1, b, b1, c1 and x, x1, y, y1, z1 are defined differently. The input of two (3m+1)-b numbers J and K is partitioned into a, b, cl and x, y, z1 respectively, so that a, b, x, y are 5-b numbers, c1 and z1 are 6-b numbers. Also b1=b plus the MSB of a, a1=a minus the MSB of a, and y1=y plus the MSB of x, x1=x minus the MSB of x. Such decomposition will make it easier to represent the partial product sub-matrices for our unified scheme. FIG. 13B illustrates the partial product matrix decomposition, which is similar to FIG. 11B except that 0 bits in m2 and m7 mean those bits are either set to 0 or not generated (refer to FIG. 13A for size measurements). Both m2 and m7 are (m+1)×(m−1) matrices, each with 4 generated bits (centered circles) moved to new positions (starts), indicated by arrows, plus the 0 bit forming an m×m matrix.

Three 1-b larger ones, i.e., (m+1)×(m+1) sub-matrices, now are m3, m9 and m8, instead of m2, m7 and m6 as shown in FIG. 13C, which makes the scheme correct, and can be obtained from only the modification of the CSA block associated with the third column of small multipliers. Since the height of the sub-matrices are actually the same (no more than two input lines of differences between sub-matrices (m+1)×(m+1) and m×m), the triple expansion scheme shown in FIG. 13C will have the same perfect rectangular shape as shown in FIG. 13D. As shown in FIG. 13C, the third column multipliers m3, m9, m8 are 6×6-b, and the others are 5×5-b base multipliers. Inputs b1, c1, y1, and z1 need to get an extra bit from their neighbor inputs (see FIGS. 13A and 13B). For the m×m-b and (m+1)×(m+1)-b base multipliers, the heights are about the same.

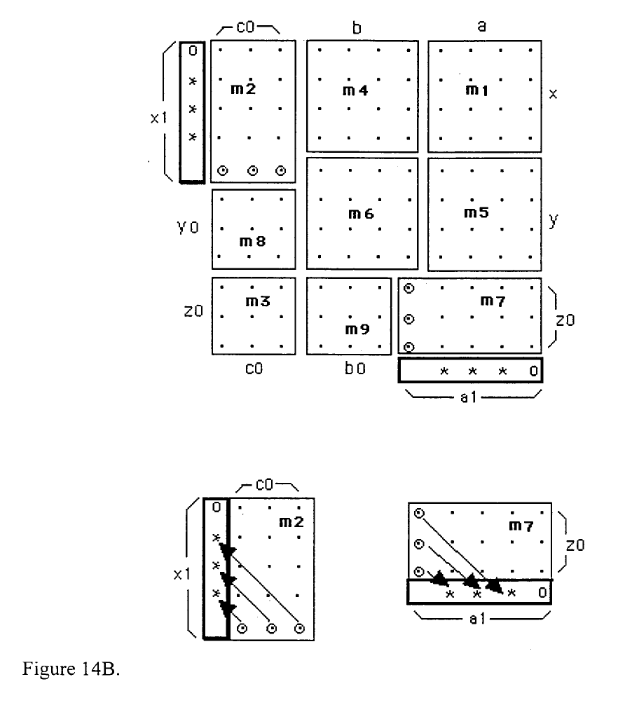

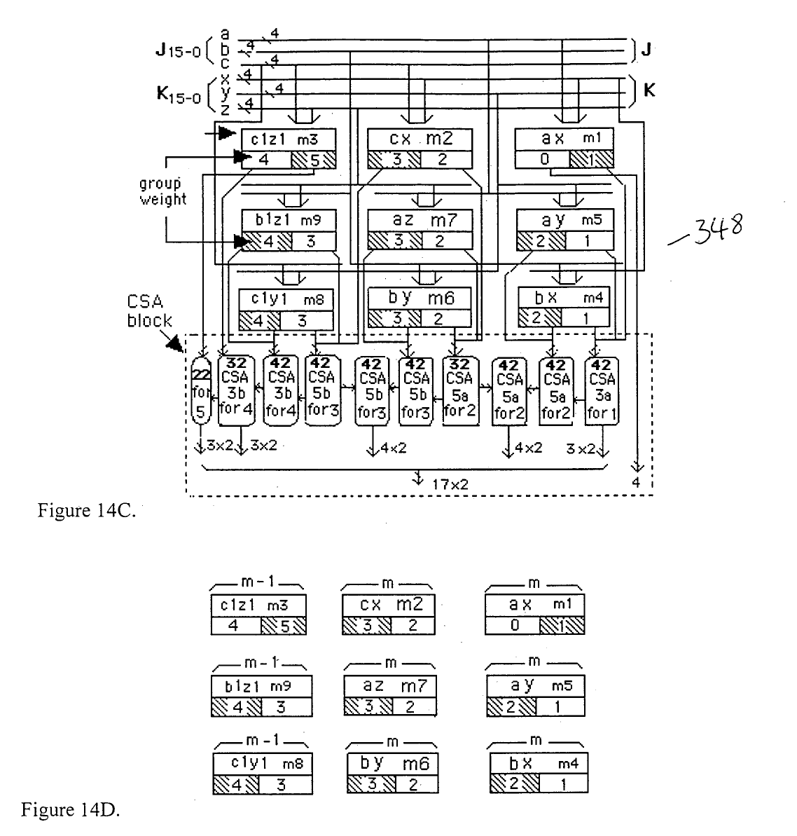

FIGS. 14A to 14D show decomposition for partial product matrices of size (3m−1)×(3m−1), which is a similar process as described above, except that the partition of the initial matrix and the size of the third column small multipliers are defined differently. The matrix 340 (FIG. 14A) is the same as the matrix 300 (FIG. 11A), except that the definitions of a, b, c and al, b0, c0 as well as x, y, z, and x1, y0, z0 are defined differently. In FIG. 14B 0 bits in m2 and m7 imply that those bits are either set to 0 or not generated. Both m2 and m7 are (m+1)×(m−1) matrices, each with 3 generated bits (centered circles) moved to new positions (starts), indicated by arrows, plus the 0 bit forming an m×m matrix. In the third column of multiplier 348 (FIG. 14C), sub multipliers m3, m9, m8 are 3×3-b, and the others are 4×4-b base multipliers. Also inputs b1, c1, y1 and z1 need to get an extra bit removed and m2, m7 need to get an extra bit from neighbor inputs. As seen in FIG. 14C, for the m×m-b and (m−1)×(m−1)-b base multipliers, the heights are about the same.

Rules for the number of base multipliers needed in a triple expansion are easy to verify and prove. These rules for multiplier triple expansion are as follows:

One-Level Construction of M×M Multiplier (for 10<=M=N<=27 and 3<=m<=9)

Case group A:

(1) if M=3m−1 requires two types of base multipliers: m×m-b and (m−1)×(m−1)-b

(2) if M=3m requires one type of base multipliers: m×m-b

(3) if M=3m+1 requires two types of base multipliers: m×m-b and (m+1)×(m+1)-b

Two-Level Construction of N×N Multiplier (for 28<=N<=81, and 10<=M<=27 and 3<=m<=9)

Case group B: if N=3M−1

(4) if M=3m−1 requires two types of base multipliers: m×m-b and (m−1)×(m−1)-b

(5) if M=3m requires two types of base multipliers: m×m-b and (m−1)×(m−1)-b

(6) if M=3m+1 requires two types of base multipliers: m×m-b and (m+1)×(m+1)-b

Case group C: if N=3M+1

(7) if M=3m−1 requires two types of base multipliers: m×m-b and (m−1)×(m−1)-b

(8) if M=3m requires two types of base multipliers: m×m-b and (m+1)×(m+1)-b

(9) if M=3m+1 requires two types of base multipliers: m×m-b and (m+1)×(m+1)-b

Case group D: if N=3M

(10) if M=3m−1 requires two types of base multipliers: m×m-b and (m−1)×(m−1)-b

(11) if M=3m requires one type of base multipliers: m×m-b

(12) if M=3m+1 requires two types of base multipliers: m×m-b and (m+1)×(m+1)-b

It should be noted that no more than two types of base multipliers are required to construct any N×N (10<=N<=85) multiplier.

Based on the unified triple expansion scheme, some examples of the multiplier constructions are presented as follows:

For 16×16, 32×32, 54×54 and 64×64 Multipliers

16×16: One level of application of the Triple expansion scheme as follows:

One level: M×M=16×16=(3m+1)×(3m+1) for m=5

Case 3, M=16, m=5, need two types of base multipliers: 5×5-b and 6×6-b

32×32: Two levels of application of the Triple expansion scheme as follows:

First level: M×M=11×11=(3m−1)×(3m−1) for m=4

Second level: N×N=(3M−1)×(3M−1) for M=11

Case 4, M=11, m=4, need two types of base multipliers: 4×4-b and 3×3-b

54×54: Two levels of application of the Triple expansion scheme as follows:

First level: M×M=18×18=3m×3m for m=6

Second level: N×N=54×54=3M×3M for M=18

Case 11, M=18, m=6, need one type of base multipliers: 6×6-b

64×64: Two levels of application of the Triple expansion scheme as follows:

First level: M×M=21 ×21=3m×3m for m=7

Second level: N×N=64×64=(3M+1)×(3M+1) for M=21

Case 8, M=21, m=7, need two types of base multipliers: 7×7-b and 8×8-b

For 23×23, 44×44, 72×72 and 81×81 multipliers

23×23: One level: M×M=23×23=(3×8−1)×(3×8−1) for m=8

Case 1, M=23, m=8, need two types of base multipliers: 8×8-b and 7×7-b

44×44: First level: M×M=15×15=3m×3m for m=5

Second level: N×N=44×44=(3M−1)×(3M−1) for M=15

Case 5, M=15, m=5, need two types of base multipliers: 5×5-b and 4×4-b

72×72: First level: M×M=24×24=3m×3m for m=8

Second level: N×N=72×72=3M×3M for M=24

Case 11, M=24, m=8, need one type of base multipliers: 8×8-b

81×81: First level: M×M=27×27=3m×3m form=9

Second level: N×N=81×81=3M×3M for M=27

Case 11, M=27, m=9, need one type of base multipliers: 9×9-b

While the invention has been shown and described with reference to certain preferred embodiments-thereof, it will be understood by those skilled in the art that various changes in form and details may be made therein without departing from the spirit and scope of the invention as defined by the appended claims.

What is claimed is:

1. An arithmetic circuit including at least one borrow parallel counter and at least one 4-bit one-hot digital signal, said circuit achieving high performance while expending low-power, said circuit comprising:
a full-adder, which adds three bits represented by two 4-b 1-hot signals and a binary signal respectively without intermediate conversion.

2. The arithmetic circuit of claim 1, wherein said borrow parallel counter is constructed of Complementary Metal Oxide Semiconductor (CMOS) and uses greater weighted input bits.

3. The arithmetic circuit of claim 1, wherein a very large semiconductor (VLSI) design is improved by increasing speed of a calculation performed by said arithmetic circuit, decreasing area-transistor count; improving nMOS/pMOS ratio, and increasing power dissipation.

4. The arithmetic circuit of claim 1, wherein said circuit includes lower switching activity and use of fewer hot lines as compared with a binary circuit for use in low-power high-performance arithmetic applications.

5. A multiplier circuit including borrow parallel multiplier circuits and virtual multiplier circuits using borrow parallel counters providing low-power, high-speed, and small-area features, said multiplier comprising:
regular and unified layouts for small multipliers of n×n, where 3≦n≦9 including a single array of almost identical borrow counters;
reduced line connections including partial product bits generations and their connections to the bit reduction networks; and
a substantially same delay for almost all output bits, wherein transistor sizing and delay equalization is minimized.

6. The multiplier circuit of claim 5, wherein a “borrow-effect” re-arranges input bits to be processed so that the actual bits to each column are balanced and equal.

7. The multiplier circuit of claim 5, wherein a total length of line connections in said multiplier is minimized due to only a single counter being used in each column.

8. A multiplier triple-expansion non-Booth circuit comprising a partial product bit matrix decomposition circuit for efficient generation of large multipliers from smaller multipliers, wherein each expansion triples the size of the large multipliers.

9. The circuit of claim 8, further minimizing inter-connections and being self-testable at high-speed and low-power, and having high VLSI performance without an extra built-in test circuit and complex wiring.

10. The circuit of claim 8, wherein said multipliers have only about 9% to 20% more transistors than minimum existing Booth multipliers.

11. The circuit of claim 8, wherein said circuit is used in pipelined and multiply-accumulate (MAC) processors for performing natural four stage operations selected from one of base virtual multiplication, level-1, level-2 bit reductions and the fast final addition.

12. The circuit of claim 11, wherein said circuit is further performs natural four stage operations with equalized delays.

13. A multiplier circuit utilizing 4-b 1-hot encoded signals and borrow bits, the circuit comprising:
at least two input numbers, each of said input numbers being trisected into three segments;
a plurality of Carry Select Adders (CSAs);
a plurality of multipliers interconnected to the CSAs, said multipliers being arranged to minimize the interconnection to the CSAs; and
a plurality of output bits.

14. A multiplier circuit of claim 13, further comprising a plurality of levels of 3:2 and 4:2 counters and a latch for each of said output bits.

15. The multiplier circuit of claim 13, wherein a 54×54-b pipelined multiplier is implemented in an area of 434.8×769.5=334,578.6 m² with a 0.18 m technology, achieving a 1 GHz at 1.8V supply and a low-power performance.

16. The multiplier circuit of claim 13, wherein at least 9 multipliers are used, said multipliers being selected from one of
6×6-b (4, 2)−(3, 2) based virtual multiplier totaling 18×18-b, and
6×6-b borrow parallel virtual multiplier totaling 18×18-b.

17. The multiplier circuit of claim 13, wherein fewer transistors for signal type conversion from non-binary to binary are required.

18. The multiplier circuit of claim 13, wherein said CSAs are 4-b 1-hot borrow parallel counters including a 5_{—}1 counter, wherein said 5_{—}1 counter uses 78 transistors, about two third being nMOS transistor cells, and 56 transistors being used to pass 4-b 1-hot signals, thereby reducing power-consuming activities.

19. The multiplier circuit of claim 18, wherein said CSAs implement equations
A1+A2+A3+A4+2A5=s0+2s1+4Q)
Xo=s0;
Yo=Xi XOR s1;
Zo=Xi;
S=Yi XOR Q; and
C=Zi AND Yi′ OR Q AND Yi, where A1-A5 are input bits with A5 being a borrow bit; s0, s1 and Q are temporary parameters; and Xo, Yo, Zo and Xi, Yi, Zi are in-stage carry (out/in) bits.

20. A small borrow parallel multiplier circuit for processing a plurality of bit inputs, the multiplier comprising:
an array including a plurality of identical counters with a simple layout arranged in a plurality of columns, wherein “borrow-effect” naturally re-arranges bits being processed so that an actual number of bits processed in each column are balanced;
minimal line connections within each line, wherein a single counter is used in each column; and
a plurality of output bits having similar delay, wherein said multiplier requiring little cost in transistor sizing and delay equalization.

21. The multiplier circuit of claim 20, wherein said delay is selected from one of about 0.6 ns and 2 times a (4, 2) delay.

22. The multiplier circuit of claim 20, wherein said multiplier has the same height as a single 5_{—}1 counter, providing extra regularity and compact layout.

23. The multiplier circuit of claim 20, wherein a 6×6 multiplier is implemented in 180 μm CMOS technology has an area of 12.87×16.0 μm² when using a 5_{—}1 counter and an area of 26.5×85.5 μm² when using a 5_{—}1_{—}1 counter.

24. The multiplier circuit of claim 20, wherein a CSA block of an 18×18 multiplier has an area of about 34.2×85.5×3 μm².

25. The multiplier circuit of claim 20, wherein a CSA block of a 54×54 multiplier has an area of about 48.7×85.5×9 μm².

26. The multiplier circuit of claim 20, wherein a 54×54 multiplier including a CSA block has a layout in a rectangular area with a height of ((26.5+5)×3+34.2)×3+48.7=434.8 μm and a width of 85.5×9=769.5 μm, equaling an area of 434.8×769.5=334,578.6 μm².

27. The multiplier circuit of claim 20, wherein components of said multiplier are modular and repeated, a low-power and pipeline frequency of 1 GHz is achieved, and said multiplier is self-testable, as provided by a triple expansion logic scheme.

28. A method of optimizing only one column of a plurality of CSA block columns in a triple expansion scheme of a multiplier for processing a plurality of bit inputs, the method comprising the steps of:
providing a first level of application of a triple expansion scheme P×P, where P is (3m+z1), m is an integer multiplier, and z1 is {0, 1, −1}; and
expanding the first level of application according to an E×E, where E is (3P+z2) and z2 is {0, 1, −1}.

29. The method of claim 28, wherein m=4, z1=−1, and z2=−1.

30. The method of claim 28, wherein m=6, z1=0, and z2=0.

31. The method of claim 28, wherein m=7, z1=0, and z2=1.

32. The method of claim 28, wherein m=5, z1=0, and z2=−1.

33. The method of claim 28, wherein m=8, z1=0, and z2=0.

34. The method of claim 28, wherein m=9, z1=0, and z2=0.
